(19) United States
(12) Patent Application Publication
(10) Pub. No.: US 2014/0103880 A1
(43) Pub. Date: Apr. 17, 2014

(54) CONVERTER CELL HAVING A CELL HOUSING, BATTERY HAVING AT LEAST TWO SUCH CONVERTER CELLS, AND METHOD FOR PRODUCING A CONVERTER CELL

(71) Applicant: Li-Tec Battery GmbH, Kamenz (DE)

(72) Inventors: Tim Schaefer, Harztor (DE); Marco Zichner, Dresden (DE); Werner Hufenbach, Dresden (DE); Detlef Dieball, Dresden (DE); Sascha Schulte, Leinfelden (DE)

(21) Appl. No.: 13/922,661

(22) Filed: Jun. 20, 2013

Related U.S. Application Data
(60) Provisional application No. 61/661,867, filed on Jun. 20, 2012.

(30) Foreign Application Priority Data
Jun. 20, 2012 (DE) 10 2012 012 790.1

(51) Int. Cl. H01M 2/02; H02J 7/00

(52) U.S. Cl. CPC H01M 2/024; H02J 7/007
USPC 320/134; 429/163; 429/179; 429/90; 429/61; 429/53; 429/82; 429/120; 429/186; 429/149; 29/623.1

(57) ABSTRACT

Converter cell having at least one particularly rechargeable electrode assembly, that is designed to at least temporarily supply electrical energy particularly to a consumer, which has at least two electrodes of different polarity, with at least one current conducting device, which is designed to be electrically, preferably materially connected to one of the electrodes of the electrode assembly, with a cell housing with a first housing section, wherein the first housing section is designed to at enclose at least areas of the electrode assembly.

### CROSS-REFERENCE TO RELATED APPLICATIONS

The present application claims the benefit of U.S. Provisional Patent Application Ser. No. 61/661,867, filed Jun. 20, 2012, the entire content of which is hereby incorporated by reference. The present application also claims priority to German Patent Application No. DE 10 2012 012 790.1, filed Jun. 20, 2012, the entire content of which is hereby incorporated by reference.

### DESCRIPTION

The present invention relates to a converter cell, particularly a converter cell in the form of an electrochemical energy converter, having a cell housing, a battery with at least two of these electrochemical energy converters, and a method for producing an electrochemical energy converter. The invention is described in the context of lithium-ion batteries for the supply to motor vehicle drives. It should be noted that the invention can also be used regardless of the chemistry of the converter cell or the construction type of the battery, or regardless of the type of drives supplied.

Batteries having multiple converter cells for supplying vehicle drives are known from the related art. Standard converter cells have an electrode assembly with at least two electrodes of opposite polarity and a separator. The separator separates or keeps the electrodes of opposite polarity apart. Standard converter cells also comprise a cell housing that encloses at least areas of the electrode assembly. Standard converter cells also have at least two current conducting devices, each of which is electrically connected to an electrode of the electrode assembly.

The high amount of effort involved in producing some converter cell construction types is sometimes considered to be a cause for concern.

One object of the invention is to provide a converter cell that can be produced with less effort and at lower cost.

This object is solved with a converter cell according to claim 1. Claim 13 describes a battery having at least two converter cells according to the invention. The object is also solved with a production method for a converter cell according to claim 14. Preferred refinements of the invention are the objects of the dependent claims.

A converter cell according to the invention, particularly constructed as an electrochemical energy converter, comprises at least one in particular rechargeable electrode assembly. The at least one electrode assembly is designed to supply electrical energy particularly to one consumer at least temporarily. The electrode assembly comprises at least two electrodes of opposite polarity. The converter cell comprises one, two or multiple current conducting devices, wherein at least one or more of said current conducting devices is designed for the purpose of being connected electrically, preferably in a bonded connection, to one of the electrodes of the electrode assembly. The converter cell comprises a cell housing that has at least one particularly first housing section, the cell housing being designed to enclose at least areas of the electrode assembly. The first housing section comprises at least one functional device that is designed to support the delivery of energy from the electrode assembly particularly to a consumer. The functional device is operatively connected to the electrode assembly, particularly in order to receive energy. The first housing section has at least a first bearing element that is designed to isolate the at least one functional device from the environment of the converter cell. The first bearing element serves in particular to support the at least one functional device, that is to say to counteract an undesirable displacement of the at least one functional device relative to the converter cell. The first bearing element serves in particular to protect the at least one functional device from harmful influences from the environment.

The at least one electrode assembly is preferably designed to convert chemical energy into electrical energy at least temporarily. The at least one electrode assembly is preferably designed to convert particularly received electrical energy into chemical energy.

In a configuration of the first housing section according to the invention, the functional device carries out multiple functions, particularly relating to the operation of the converter cell and the electrode assembly, which functions are performed by discrete components in known converter cell construction types. Multiple discrete components or functional elements are combined in particular to form a separate functional assembly in the at least one functional device. In this way, fewer assemblies are required in order to produce the converter cell according to the invention, which in turn results in a reduction of production and installation effort. In this way, the underlying object is solved.

The converter cell according to the invention offers the further advantage of a longer shelf life because the first bearing element protects the functional device, which is arranged underneath it, from mechanical damage, particularly due to the action of a foreign body on the cell housing. The converter cell according to the invention offers the further advantage of a longer shelf life because the first bearing element also improves the solidarity of the functional device particularly during periods of acceleration or vibration while the converter cell is operating. For the purposes of the invention, an electrode assembly is understood to be a device that serves in particular to make electrical energy available.

The electrode assembly comprises at least two electrodes of opposite polarity. These electrodes of opposite polarity are kept apart by a separator, the separator being conductive for ions but not for electrons. The electrode assembly is preferably cuboid in shape. The electrode assembly is preferably connected, particularly by a bonded connection, with two of said current conducting devices of opposite polarity, said current conducting devices serving to provide an at least indirect electrical connection to at least one adjacent electrode assembly and/or to provide an at least indirect electrical connection to the consumer.

At least one of said electrodes preferably has in particular a metal collector foil and active mass. The active mass is applied to at least one side of the collector foil. When the electrode assembly is charged or discharged, electrons are exchanged between the collector foil and the active mass. Preferably, at least one electrode tabis connected, particularly by a material connection, to the collector foil. Particularly preferably, a plurality of electrode tabs are connected to collector foil, particularly by a material connection. The advantage of this configuration is that the current through each electrode tabis reduced.

At least one of said electrodes preferably has in particular a metal collector foil, and two active masses of opposite polarity which are arranged on different surfaces of the collector foil and kept apart from each other by the collector foil. The term “bicell” is also commonly used to describe this arrangement of active masses. When the electrode assembly is charged or discharged, electrons are exchanged between the collector foil and the active mass. Preferably, at least one electrode tabis connected, particularly by a material connection, to the collector foil. Particularly preferably, a plurality of electrode tabs is connected to collector foil, particularly by a material connection. The advantage of this configuration is that the number of electrons flowing through an electrode tabper unit of time is reduced.

Two electrodes with opposite polarity are separated in the electrode assembly by a separator. The separator is permeable for ions, but not for electrons. The separator preferably contains at least some of the electrolyte or the conducting salt. The electrolyte is preferably formed in particular after the converter cell is sealed, and is essentially without a liquid fraction. The conducting salt preferably contains lithium. Particularly preferably, lithium ions are stored or intercalated in the negative electrode during charging, and displaced again during discharging.

The electrode assembly preferably designed such that it is able to convert supplied electrical energy into chemical energy and store it as chemical energy. The electrode assembly is preferably designed particularly such that it is able to convert stored chemical energy into electrical energy before the electrode assembly makes this electrical energy available to a consumer. This is also referred to as a rechargeable electrode assembly. Particularly preferably, lithium ions are stored or intercalated in the negative electrode during charging, and displaced again during discharging.

According to a first preferred variation, the electrode assembly is designed as an electrode winding, particularly as an essentially cylindrical electrode winding. Said electrode assembly is preferably rechargeable. This variation offers the advantage of simpler production, particularly due to the fact that strip-like electrodes can be processed. This variation offers the advantage that the charge capacity, expressed for example in Ampere hours [Ah] or Watt hours [Wh], less often in Coulombs [C], can be increased easily by adding further windings. The electrode assembly is preferably designed as a flat electrode winding. This variation offers the advantage that it may be arranged beside another flat electrode winding and takes up little space, particularly inside a battery.

According to another preferred variation, the electrode assembly is designed as an essentially cuboid electrode stack. Said electrode assembly is preferably rechargeable. The electrode stack has a predetermined sequence of stack sheets, wherein two electrode sheets of opposite polarity are each separated by a separator sheet. Preferably, each electrode sheet is connected to a current conducting device, particularly with a material connection, particularly preferably integrally with the current conducting device. Electrode sheets with the same polarity are preferably electrically connected to each other particularly via a common current conducting device. This variation of the electrode assembly offers the advantage that the charge capacity, expressed for example in Ampere hours [Ah] or Watt hours [Wh], less often in Coulombs [C], can be increased easily by adding further electrode sheets. Particularly preferably, at least two separator sheets are connected to each other and surround an adjacent edge of an electrode sheet. Such an electrode assembly, with a single, particularly serpentine separator, is described in WO 2011/020545. This variation offers the advantage that a parasitic current emanating from this delimiting edge with an electrode sheet of opposite polarity is counteracted.

According to a third preferred variation, the electrode assembly is designed such that it is able to supply electrical energy through the uptake of at least one continuously supplied fuel and an oxidising agent, hereinafter referred to as process fluids, the chemical reaction between said fluids to form a reactant, particularly aided by at least one catalyst, and the release of the reactant. In the following, the electrode assembly according to this preferred variation will also be called a converter assembly. The converter assembly constructed as an essentially cuboid electrode stack and has at least two electrodes, particularly sheet electrodes of opposite polarity. Preferably, at least areas of at least the first electrode are coated with a catalyst. The electrodes are separated, preferably by a separator or a membrane that is permeable to ions but not to electrons. The energy converter also has two fluid feed devices, which are arranged adjacent to each electrode of opposite polarity and are designed to feed the process fluids to the electrodes. At least one of the fluid feed devices is preferably designed to remove the reactant. The converter assembly has at least one of the sequences: fluid feed device for the fuel—electrode of first polarity—membrane—electrode of second polarity—fluid feed device for the oxidising agent, in particular also for the reactant. Preferably, a plurality of these sequences is connected in series for increased electrical voltage. While the energy converter is operating, the fuel is fed to the first electrode, particularly as a stream of fluid, via channels in the first fluid feed device. At the first electrode, the fuel is ionised and releases electrons. The electrons are transported away via the first electrode, particularly via one of the current conducting devices, particularly towards an electrical consumer or an adjacent converter cell. The ionised fuel passes through the membrane, which is permeable for ions, to the second electrode. The oxidising agent is fed to the second electrode, particularly as a fluid stream, via channels in the second fluid feed device. At the second electrode, the oxidising agent, the ionised fuel and electrons from the electrical consumer or an adjacent converter cell meet. The chemical reaction forming the reactant takes place at the second electrode and the reactant is transported away preferably via channels of the fluid feed device of the second electrode.

For the purposes of the invention, a current conducting device is understood to be a device that serves particularly to conduct electrons between one of the electrodes in the electrode assembly and a consumer, or between one of the electrodes and an adjacent converter cell. For this purpose, the current conducting device is connected, preferably by material connection, to one of the electrodes of the electrode assembly. The current conducting device is preferably at least indirectly connected to a consumer that is to be supplied with electrical power.

The current conducting device has an electrically conductive area with a metal material, preferably aluminium and/or copper, which is particularly preferably covered at least in parts with a coating containing nickel. This variation offers the advantage of reduced contact resistance. The current conducting device is preferably made from a solid metal material. The material of the current conducting device is preferably the same as the material of the collector foil of the electrode with which the current conducting device is in particular materially connected. This variation offers the advantage of reduced contact corrosion between the current conducting device and the collector foil.

The current conducting device has a second area, which is located inside the converter cell. The second area is electrically and preferably materially connected to at least one electrode of the electrode assembly, preferably to all of the electrodes with the same polarity.

The second area is preferably furnished with at least one electrode tab. Die electrode tabis connected, particularly materially connected, to one of the electrodes of the electrode assembly, particularly to the collector foil thereof. The electrode tabhas the form of an electrically conductive strip or foil, preferably a metal foil. This variation offers the advantage that an offset between a plane of symmetry through the area of the current conducting device that extends into the area outside the converter cell, and a plane through said electrode and collector can be compensated for. Particularly preferably, the second area is furnished with multiple electrode tabs. The electrode tabs offer a plurality of current paths to the same electrode, so that the current density per current path is advantageously reduced, or to different electrodes with the same polarity in the electrode stack, thereby forming a parallel circuit of the electrode with the same polarity.

The current conducting device preferably also has a first area that extends into the area around the converter cell. The first area is electrically connected at least indirectly to a consumer that is to be supplied or to a second, particularly adjacent converter cell, preferably via a connecting device that is not associated with the converter cell, wherein for the purposes of the invention a busbar, a power band or a connection cable may also be considered to be a connecting device. According to a preferred variation, the first area is realised as a metal plate or a plate having a metal coating. This variation offers the advantage that a mechanically stable, essentially flat surface is provided for a simple and/or as far as possible permanent electrical connection with a connecting device.

The current conducting device preferably has an essentially plate-like, metal or metal-coated current collector. In the second area of the current conducting device, the current collector is connected, particularly materially, in particular to all electrode tabs with the same polarity. The material of the current collector is preferably that same material as the electrode tab. This variation offers the advantage that the current collector may be designed for connection to an connecting device and/or one of the housing parts in a more mechanically robust manner than could an electrode tabin the form of a foil. In this way, the service life of the converter cell is improved. This variation further offers the advantage that the current collector can be connected to the cell housing before the electrode assembly with the electrode tabs attached is attached to cell housing.

For the purposes of the invention, a cell housing is understood to be a device that in particular
serves to isolate the electrode assembly from the external environment,
serves to protect the electrode assembly from harmful factors in the external environment, particularly from water in the external environment,
hinders the escape of substances from the electrode group into the external environment,
preferably encloses the electrode assembly in essentially gas-tight manner.

The cell housing at least partially encloses the electrode assembly, preferably essentially completely. To this end, the cell housing is adapted to the shape of the electrode assembly. The cell housing, and the electrode assembly, are preferably essentially cuboid in shape. The cell housing preferably surrounds the electrode assembly in such manner that at least one wall of the cell housing exerts a force on the electrode assembly, and said force counteracts any undesirable movement of the electrode assembly relative to the cell housing. The cell housing particularly preferably engages with the electrode assembly with a material and/or force-fitting connection. The cell housing is preferably electrically insulated from the external environment. The cell housing is preferably electrically insulated from the electrode assembly.

The cell housing is constructed with at least one essentially rigid first housing section. The first housing section is equipped with at least one functional device which assists with the release of energy from the electrode assembly particularly to a consumer. The first housing section has a first bearing element, which braces the at least one functional device against the area outside the converter cell. In particular, the first housing section serves to isolate the electrode assembly from the area outside the converter cell, and to protect the electrode assembly. In particular, the first housing section serves to protect the electrode assembly. The first housing section preferably has a wall thickness of at least 0.3 mm. The material and geometry of the first housing section are preferably chosen so that the rigidity thereof is able to withstand the stresses generated during operation.

For the purposes of the invention, a functional device is understood to be a device that particularly serves to support the flawless operation of the electrode assembly. The functional device operatively connected to the electrode assembly. For the purposes of the invention, an operatively connected functional device and electrode assembly are particularly understood to mean that energy, an electrical potential, substances and/or information, particularly relating to operating parameters of the electrode assembly can be exchanged between the functional device and the electrode assembly. The at least one functional device is preferably furnished with at least one electrically conductive area. The at least one functional device is preferably furnished with at least one electrically insulating area, which particularly preferably serves as a carrier for functional elements. The functional device is preferably connected, particularly with a material connection, to the first bearing element. The functional device is essentially completely covered by the first bearing element, and is thus isolated from the external environment, if the first bearing element does not have any pole contact recesses.

The functional device is preferably electrically connected to at least one of the electrodes, particularly preferably to at least two electrodes having opposite polarity. This configuration offers the advantage that the functional device has the electrical potential of the connected electrode, and in particular can be supplied with energy by the electrode assembly.

The functional device is preferably realised as a diffusion barrier that prevents a gas from being exchanged between the area outside the converter cell and the interior space of the cell housing.

The functional device is preferably realised as an assembled and/or printed, particularly flexible circuit board. This variation offers the advantage that the circuit board is protected by the first bearing element. is variation offers the advantage that the circuit board remains on the converter cell when the converter cell is removed from a battery.

The functional device is preferably realised as a flame retardant or fire retardant. To this end, the functional device includes one of these chemically reactive, flame-inhibiting substances and is preferably designed as a layer or ply and in particular essentially completely covers the adjacent electrode assembly. This variation offers the advantage that the operating reliability of the converter cell is improved in the event of a fire in the area around it.

For the purposes of the invention, a first bearing element is understood to be a device that is designed to serve as a brace for at least a part of the at least one functional device. The first bearing element faces towards the exterior outside the converter cell. For the purposes of the invention, the term “brace” is understood to mean that it counteracts an undesirable movement of the at least one functional device relative to the first bearing element and the converter cell. The first bearing element particularly services to counteract an undesirable shift of the at least one functional device relative to the first bearing element and the converter cell. The first bearing element particularly serves to protect the at least one functional device particularly from harmful factors from the area outside the converter cell. Thus, this embodiment offers the advantage of protection of the electrode assembly from a foreign body that may affect or even penetrate the cell housing, particularly without the need for separate protective devices.

The first bearing element includes a first polymer material, preferably a thermoplastic that is in particular interfused with fibres. This softening temperature of the polymer material is preferably higher than the operating temperature range of the converter cell, particularly preferably by at least 10 K. The first bearing element preferably includes a fibre material, particularly glass fibres, carbon fibres, basalt fibres and/or aramid fibres, wherein the fibre material particularly serves to stiffen the first bearing element. The fibre material particularly preferably is designed in the form of a textile, as a multi-ply weave or woven fabric, and is essentially completely surrounded by the first polymer material.

The at least one functional device is preferably connected, particularly with a material connection, to the first bearing element.

The first bearing element is preferably designed as a first base course. This variation offers the advantage that the at least one functional device can be braced by the first bearing element along a relatively large area, so that in particular the integrity of the at least one functional device is improved.

The first bearing element preferably has one or two pole contact recesses, each of which allow particularly electrical access to an area of the adjacent functional device from the area outside the converter cell.

In the following, advantageous variations and preferred embodiments of the converter cell according to the invention and advantages thereof will be described.

The converter cell according to the invention preferably comprises at least two electrode assemblies, which are connected in series in the cell housing. This variation offers the advantage that the electrical voltage the converter cell is able to provide, particularly the terminal voltage of the converter cell, is increased.

The at least one functional device preferably has at least one or more functional elements.

For the purposes of the invention, a functional element is understood to be an element that serves in particular to support the flawless operation of the electrode assembly. The functional element is used in particular
for the electrical connection of the electrode assembly to the outside of the converter cell, and/or
for the electrical connection in particular of at least one or more of said functional devices to the electrode assembly, and/or
to feed energy particularly from the electrode assembly to at least one or more of said functional devices, and/or
to influence or limit the electrical current that flows into the electrode assembly or is transported away from the electrode assembly, and/or
to control the converter cell and electrode assembly, and/or
to capture operating parameters of the converter cell, particularly operating parameters of the electrode assembly, and/or
to exchange thermal energy with the electrode assembly, preferably to transport heat away from the electrode assembly, and/or
to introduce or transport away a fluid stream of a chemical substance, and/or
to capture the safety status of the converter cell, to perform a fault analysis, to capture and/or report on the status, and/or
to communicate with the outside area, particularly with a battery controller or an independent controller.

At least one or more of said functional elements is preferably constructed as
a pole contact area that is accessible from outside the converter cell, particularly through a pole contact recess in the first bearing element, which is arranged on an outer surface of the cell housing, wherein the pole contact area has the electrical potential of one of the electrodes of the electrode assembly, wherein this variation offers the advantage that at least one of said current conducting devices can be constructed without a first area,
an electrode connection area that serves to provide an electrical connection between the functional device and the electrode assembly, that serves particularly to supply the functional device, that particularly serves to provide an electrical connection with one of the current conducting devices of the converter cell,
a voltage probe, a current probe, a temperature probe and thermocouple, pressure sensor, sensor for a chemical substance, hereinafter referred to as a “substance sensor”, gas sensor, liquid sensor, position sensor or acceleration sensor, wherein the sensors or probes are used in particular to capture operating parameters of the converter cell, particularly the electrode assembly,
a control device, particularly a cell control device, application-specific integrated circuit, microprocessor or data storage device, which are particularly used to control the converter cell and its electrode assembly,
a setting device, an actuator pressure relief device, a switching device, a semiconductor switch, a discharge resistor, a current limiter or circuit breaker, which are particularly used to carry out switch-off functions upon detection particularly of undesirable operating states of the converter cell, which are particularly used to influence or limit the electrical current into and out of the electrode assembly,
a conductor path that serves to create an electrical interconnection among at least two or more of said functional elements,
a recess that enables a connection of bodies that are separated by the functional device, or that enables a body to extend through the functional device,
a heat exchanger area that is used for exchanging thermal energy with the electrode assembly,
a fluid passthrough, which is used for the exchange of a chemical substance with the electrode assembly, or as
a beeper, a light emitting diode, an infrared interface, GPS devices, GSM assembly, first short range radio device or transponder, which are used for communication particularly with a battery controller or an independent controller, which are used to transmit data particularly to a battery controller or an independent controller, which are used particularly to display particularly a predetermined operating state of the converter cell or the electrode assembly.

The first short-range radio device is preferably designed to intermittently transmit a predetermined second signal, particularly upon request or in response to a predetermined first signal from a second short-range radio device, wherein the second short-range radio device is call-connected to a battery controller. The first short-range radio device is particularly preferably designed to send an identification for the converter cell simultaneously with the predetermined second signal.

Preferably, multiple functional elements work together to ensure flawless operation of the electrode assembly. These functional elements are particularly preferably connected to each other electrically.

A first preferred variation of the functional device includes at least the following as functional elements:
one of said current probes for capturing the electric current that is fed to the electrode assembly or drawn from the electrode assembly, hereinafter also called the cell current,
one of said voltage probes for capturing the electric voltage of the electrode assembly,
one of said thermocouples for capturing the temperature of the electrode assembly or one of said current conducting devices,
one of said cell control devices for processing signals from the sensing elements, particularly those described in the preceding,
one, preferably two of said electrode connection areas, which are electrically connected to one, preferably two of said electrodes particularly having opposite polarity, which are preferably used to supply the cell control device and/or at least one of said sensing elements with electrical energy,
at least two or more of said conductor paths for electrically connecting the other functional elements of said functional device,
preferably at least one or more of said switching devices, said circuit breakers and/or said current limiters,
preferably said data storage device, which serves to store and/or provide data and/or calculation rules,
preferably said first short-range radio device, which serves to exchange data with a battery controller and the second short-range radio device thereof,
preferably two cell controller connectors, which are used for connecting to a data bus of a higher-level battery, which serve to exchange data with a battery controller,
preferably two heat exchange areas, which are used for the exchange of thermal energy with the electrode assembly and a heat exchanger that is not associated with the converter cell.

This preferred variation of the functional device offers the advantage that the functional device may be used to control and/or monitor the electrode assembly. This variation offers the advantage that the function device remains attached to the converter cell when the converter cell is removed from a battery.

According to a first preferred refinement of this preferred variation, the functional device is designed with a circuit board on which said functional elements have been assembled, which is furnished with conductor tracks for connecting the other functional elements. This preferred refinement offers the advantage that when the first housing section is manufactured the circuit board can be easily attached to or placed on top of said first bearing element. This preferred refinement offers the advantage that the circuit board remains on the converter cell when the converter cell is removed from a battery.

According to a further preferred refinement of this preferred variation, the functional device is designed with a flexible foil, particularly made from polyimide or Kapton®, which is furnished with said functional elements, which has conductor tracks for connecting the other functional elements. This preferred refinement offers the advantage that when the first housing section is manufactured the functional device can be easily attached to or placed on top of said first bearing element. This preferred refinement offers the advantage that the functional device remains on the converter cell when the converter cell is removed from a battery

Preferably, at least one or more of said functional devices are
of porous construction, particularly preferably constructed with a foam, with which in particular a predetermined external geometry of the converter cell may be realised, with which in particular the bending stiffness of the first housing section is increased, with which in particular a volume is created in areas for slowing and/or absorbing a foreign body that impinges on the converter cell, with which in particular an area of the first housing section having reduced thermal conductivity is formed, and/or
constructed with a cavity structure, particularly a honeycomb structure, with which in particular the bending stiffness of the first housing section is increased, with which in particular a volume is created in areas for slowing and/or absorbing a foreign body that impinges on the converter cell, with which in particular an area of the first housing section having reduced thermal conductivity is formed, and/or
constructed with at least one cavity particularly for a temperature control medium, wherein the temperature control medium is used for the exchange of thermal energy with the electrode assembly, wherein the temperature control medium flows through the cavity particularly if the temperature of the electrode assembly exceeds or falls below a respective limit temperature, and/or
provided at least in areas thereof with a filler that is designed to form hollow spaces, particularly when an activation energy is introduced, particularly to form hollow spaces when triggered by a functional element, and/or
constructed at least in areas thereof with a filler (PCM) that has phase transition capability, particularly within the predetermined operating temperature range of the converter cell, wherein the filler temporarily exchanges thermal energy particularly with the electrode assembly in order to heat it up or cool it down, and/or
constructed at least in areas thereof with a chemically reactive filler that is preferably designed to chemically bind a substance particularly escaping from the electrode assembly, preferably after the substance has been released from the electrode assembly, and/or
constructed with a first layer area having a first wall thickness (thick) and a second layer area having a second wall thickness (thin), wherein the fraction resulting from dividing the second wall thickness by the first wall thickness is equal to a predetermined value less than 1, preferably less than 0.9, preferably less than 0.8, preferably less than 0.7, preferably less than 0.6, preferably less than 0.5, preferably more than 0.05, wherein the first layer area preferably has a lower density than the second layer area.

According to a first preferred embodiment, the expandable filler is formed by an organic aerogel with a three-dimensional structure of primary particles. In the event of pyrolysis or intense thermal radiation, these primary particles grow without any internal order, so that hollow spaces are created between the particles. These hollow spaces serve to lower the thermal permeability of the functional device. This embodiment offers the advantage of improved flame resistance of the first housing section.

According to a further preferred embodiment, the expandable filler consists of expanded mica granulate or vermiculite. Chemically bonded water of crystallisation between the layers of its cake-like structure. Under the effects of heat, the chemically bonded water is driven off very rapidly, and the vermiculite swells to many times its original volume.

The chemically reactive filler preferably functions as a flame retardant, particularly by forming a protective layer or by interrupting a chain reaction with radicals. The filler is preferably selected from the following group, which includes: alum, borax, aluminium hydroxide, substances with M^{I}M^{III}(SO₄)₂ and with water of crystallisation, where M stands for a metal ion with oxidation state I or III, particularly preferably potassium-aluminium-sulphate. According to a first preferred embodiment, the functional device has the form of an insert impregnated with the filler, particularly preferably a cotton sheet. According to a second preferred embodiment, the functional device is compacted from a powder of the filler. This preferred embodiment offers the advantage that the protection of the electrode assembly is improved in the event of a fire in the vicinity of the converter cell.

The converter cell and the cell housing thereof preferably has a second housing section.

For the purposes of the invention, a second housing section is understood to mean a device that is designed in particular to be or become connected to the first housing section at least in areas. The second housing section is designed to cooperate with the first housing section to form the cell housing of the converter cell. The first housing section and the second housing section together preferably surround the electrode assembly essentially completely and in particular hinder the exchange of substances between the electrode assembly and the area outside the converter cell. The second housing section has at least one first bearing element, which essentially corresponds to the first bearing element of the first housing section. The second housing section preferably has at least one of said functional devices. The second housing section is particularly preferably essentially identical to the first housing section. This variation offers the advantage that manufacturing cost and warehousing are reduced.

In a first preferred embodiment of the cell housing, the first housing section and the second housing section are connected to one another via a hinged area. The hinged area extends along one edge each of the first housing section and the second housing section. The wall of the hinged area is preferably thinner than the areas of the housing sections that delimit the electrode assembly. This embodiment offers the advantage that the length of the edges of the particularly cuboid cell housing that are to be sealed is reduced.

In a second preferred embodiment of the cell housing, the first housing section and the second housing section are separated by a frame. The housing sections are connected to the frame particularly in a material connection. The frame essentially comprises four frame elements, which are arranged relative to each other to form a rectangle. The frame delimits a space in which the electrode assembly may be accommodated. A converter cell with no functional devices that has a cell housing constructed with frames has also been called a frame flat cell. The frame is preferably constructed from the second polymer material, particularly preferably essentially completely from the second polymer material. This preferred embodiment offers the advantage that each of the housing sections can be formed without an accommodation space. According to a preferred refinement two of said current conducting devices extend at least partly through the frame and into the surrounding area. According to a further preferred refinement, at least one of said housing sections has one or two of said pole contact areas.

The first housing section and/or the second housing section preferably has/have an accommodation space that is able to at least partially accommodate the electrode assembly.

Said accommodation space is preferably dimensioned such that when the housing sections have been closed around the electrode assembly to form a cell housing, a frictional force exists between at least one internal surface of the cell housing and a shell surface of the electrode assembly. Said frictional force prevents undesirable movement of the cell housing and the electrode assembly relative to one another.

According to a preferred variation, the accommodation spaces of the first housing section and the second housing section are constructed identically. In this preferred variation, essentially one half of the electrode assembly is accommodated by each housing section. This variation offers the advantage that production costs and warehousing are reduced.

According to a further preferred variation, the first housing section accommodates the electrode assembly essentially completely. The first housing section is preferably in the form of a cup. The electrode assembly is arranged in the interior space of the cup, and the interior space corresponds to the accommodation space. At least one functional device is arranged in the multilayer wall of the cup. In this preferred variation, the second housing section is constructed as an essentially flat cover without an accommodation space and/or without a functional device for closing the first housing section. This variation offers the advantage that the second housing section can be manufactured more inexpensively. According to a preferred refinement, two of said current conducting devices extend at least partially through the wall of the cup or the wall of the cover and into the outside area. According to a further preferred refinement, the cover and/or the cup have two of said pole contact areas.

The first and/or second housing section preferably has/have a second bearing element, which is arranged between at least one of said functional devices and the electrode assembly.

For the purposes of the invention, a second bearing element is understood to be a device that is designed to stiffen the housing section. The second bearing element is preferably arranged between the at least one functional device and the electrode assembly. The second bearing element is preferably in the form of a second base course. The second bearing element includes a first polymer material, preferably a thermoplastic, which first polymer material is in particular interfused with fibres. Said softening temperature is preferably higher than the operating temperature range of the converter cell, particularly preferably by at least 10 K. The second bearing element further includes a fibre material, particularly glass fibres, carbon fibres, basalt fibres and/or aramid fibres, which particularly serves to stiffen the second bearing element. The fibre material is preferably designed particularly in the form of a textile, as a multi-ply weave or woven fabric, and is particularly preferably essentially completely surrounded by the first polymer material. This variation offers the further advantage that the second bearing element separates the at least one functional device from the substances of the electrode assembly.

The second bearing element is particularly preferably connected to the at least one functional device, particularly with a material connection. This variation offers the advantage that second base course lends the housing section additional stiffness and mechanical stability.

The second bearing element is particularly preferably constructed identically to the first bearing element with regard to materials. This variation offers the advantage of reduced manufacturing costs.

The second bearing element is particularly preferably thinner than the first bearing element, and in particular is constructed without fibre material. This variation offers the advantage that time constant when recording the temperature of the electrode assembly and/or the interior cell pressure is reduced.

The second bearing element is particularly preferably furnished with at least one recess, which allows a sensor of the functional device direct contact with the electrode assembly for detecting a substance. This variation offers the advantage that the presence of hydrogen fluoride, referred to hereinafter as HF, may be detected with a shorter time constant.

The second bearing element particularly preferably has at least one contacting recess, particularly in a peripheral area of the housing section, which in particular enables the functional device adjacent to the second bearing element to be electrically connected to one of the current conducting devices of the converter cell. This variation offers the advantage that the functional device has the electrical potential of one of the electrodes of the electrode assembly. This variation offers the further advantage that the functional device can be supplied with energy by the electrode assembly.

The peripheral area of the first and/or second housing section(s) preferably includes a second polymer material. The second polymer material serves in particular to form a material connection with one of the other housing sections, particularly preferably a material connection between the first housing section and the second housing section. Said softening temperature of the second polymer material is preferably higher than the operating temperature range of the converter cell, particularly preferably by at least 10 K. This variation offers the advantage that the permanent seal of the interior space of the cell housing is improved.

The second polymer material particularly preferably has the form of a thermoplastic with a softening temperature higher than the operating temperature range of the converter cell. This variation offers the advantage of easier introduction of the second polymer material into a processing device, particularly a moulding tool. This variation offers the further advantage of a tight, particularly gas-impermeable connection between the second polymer material and the respective housing section.

The second polymer material particularly preferably surrounds a peripheral area of the first and/or second housing section(s). This variation offers the advantage of a tight, particularly gas-impermeable connection between the second polymer material and the respective housing section.

The second polymer material particularly preferably corresponds to the first polymer material. This variation offers the advantage of a tight, particularly gas-impermeable connection between the second polymer material and the first polymer material.

The converter cell, particularly the cell housing thereof, preferably has an essentially plate-shaped third housing section.

For the purposes of the invention, a third housing section is understood to be a device that is designed to be connected to the first housing section, at least in areas thereof. The third housing section is designed to be connected at least in areas, and particularly with a material connection, to the first housing section and/or together with the first housing section to form the cell housing of the converter cell. The third housing section has greater thermal conductivity than the first housing section. This variation offers the advantage that the third housing section helps to improve the transfer of heat away from the electrode assembly.

The third housing section preferably includes a metal, particularly preferably aluminium and/or copper. This variation offers the advantage that the third housing section helps to improve the transfer of heat away from the electrode assembly. This variation offers the further advantage that the protection of the electrode assembly from harmful effects from the area surrounding the converter cell is improved.

The third housing section preferably has a first heat transfer area, which is designed to enable the exchange of thermal energy with the electrode assembly. Said heat transfer area particularly preferably features geometries designed to increase the surface area, particularly protrusions, pins, cones and/or ridges, which face toward the area surrounding the converter cell. This variation offers the advantage that the third housing section helps to improve the transfer of heat away from the electrode assembly.

The third housing section preferably has a second heat transfer area that is designed to exchange thermal energy with a temperature control device that is not associated with the converter cell. The second heat transfer area is particularly preferably polished. This variation offers the advantage that surface area for thermal contact with the temperature control device is enlarged. This variation offers the advantage that the third housing section helps to improve the transport of heat away out of the electrode assembly.

The surface of the third housing section facing towards the electrode assembly and the first housing section is preferably coated in electrically insulating manner. This variation offers the advantage that the third housing section does not have the electrical potential of the electrode assembly.

The third housing section preferably has an electrode connection area and a pole contact area. The electrode connection area and the pole contact are electrically connected to one another. This variation offers the advantage that the electrode assembly may be electrically contacted via the third housing section. This variation offers the further advantage that at least one of the current conducting devices may be constructed without a first area.

At least one or two of said current conducting devices preferably each have at least one contacting area. The contacting area particularly serves to enable electrical connection with at least one or more of said functional devices, preferably the electrical supply to at least one or more of said functional devices. At least one of said contacting areas preferably contains a metal, particularly preferably aluminium and/or copper.

The contacting area is preferably arranged in a peripheral area of the first housing section, particularly in the area of the second polymer material. The second polymer material preferably leaves the contacting area free opposite at least one of said electrode connection areas. This variation offers the advantage that the contacting area is kept essentially immovable relative to the first housing section by the second polymer material. This variation offers the further advantage that the second polymer material protects the electrical connection between the contacting area and the electrode connection area of the functional device against chemical stress from the area outside the converter cell.

The contacting area is preferably constructed as a protrusion that extends towards the functional device, particularly through one of said contacting recesses. The contacting area is particularly preferably constructed as a hump. This variation offers the advantage that the connection between the current conducting device and the functional device is readily automatable.

The connection between the contacting area and the electrode connection area is preferably a material connection, particularly preferably created by a friction welding or ultrasonic welding process. This variation offers the advantage that the connection between the current conducting device and the functional device is readily automatable.

One or two of said current conducting devices preferably have one or more each of said electrode tabs, particularly in the second area thereof, particularly in the interior space of the cell housing. These multiple electrode tabs are designed to provide an electrical, particularly material connection with the same electrode of the electrode assembly that is constructed as an electrode winding, or with multiple electrodes with the same polarity as the electrode assembly that is constructed as an electrode stack. These multiple electrode tabs are preferably connected electrically, particularly materially, to the same electrode of the electrode assembly that is constructed as an electrode winding, or to multiple electrodes with the same polarity as the electrode assembly constructed as an electrode stack.

The current conducting device preferably also has:
1. an essentially plate-shaped, metal or metal-coated current collector that is designed to ensure an electrical, particularly material connection with at least one or more of said electrode tabs, which extends into the interior of the cell housing, which particularly preferably extends at least partly out of the cell housing into the area surrounding the converter cell, particularly in order to connect electrically with a connecting device that is not associated with the converter cell, or
2. an essentially plate-shaped, metal or metal-coated current collector that is designed to ensure an electrical, particularly material connection with one of said functional devices, which extends at least partly out of the cell housing into the area surrounding the converter cell, particularly in order to connect electrically with a connecting device that is not associated with the converter cell, wherein the at least one electrode tabis electrically, particularly materially connectable to the same functional device, or
3. an essentially plate-shaped, metal or metal-coated current collector having a tab connection section and a connector connecting section, wherein the tab connection section extends at least partly into the interior of the cell housing and is designed to enable electrical, particularly material connection with the at least one electrode tab, wherein the connector connecting section extends at least partly out of the cell housing and into the area surrounding the converter cell, and is designed to enable electrical, particularly material connection with a connecting device that is not associated with the converter cell, wherein the tab connection section and the connector connection section are electrically, particularly materially connectable to the same of said functional devices, wherein the tab connecting section and the connector connecting section may be electrically interconnected with each other reversibly through said functional device.

The current conducting device according to No. 1 offers the advantage of improved mechanical stability because the electrode tabs suppress the transfer of mechanical vibrations to the electrode assembly during operation of the converter cell.

The current conducting device according to No. 2 offers the advantage of improved mechanical stability because the electrode tabs suppress the transfer of mechanical vibrations to the electrode assembly during operation of the converter cell. The current conducting device according to No. 2 offers the advantage, of simplified construction.

The current conducting device according to No. 3 offers the advantage of improved mechanical stability because the electrode tabs suppress the transfer of mechanical vibrations to the electrode assembly during operation of the converter cell. The current conducting device according to No. 3 offers the advantage that said cell current can be interrupted by means of the functional device.

The multiple electrode tabs with the same polarity are preferably connected to the current collector or the tab connecting section by a friction welding process. This preferred variation offers the advantage of slower aging of the connection.

The current collector is preferably connected, particularly materially, to the first housing section, particularly in the peripheral area thereof. Particularly preferably, the current collector extends through the second polymer material in the peripheral area of the first housing section. In this way, in a first manufacturing step the current collector may be connected materially and particularly in gas-tight manner to the first housing section, and in a following manufacturing step the electrode tabs may be connected materially, particularly welded to the current collector. This variation offers the advantage that thermal energy is applied during the first manufacturing step, and since the electrode assembly is absent at this time, it is not exposed to the heat and the associated accelerated aging.

According to a first preferred embodiment of the current conducting device, the current collector also extends out of the cell housing, also into the first area of the current conducting device and into the area surrounding the converter cell. One or more of said electrode tabs with the same polarity are connected electrically, particularly materially, to the current collector inside the cell housing. The current collector is preferably realised as a metal plate, a punched part and/or a sheet metal part. This preferred embodiment offers the advantage of low production costs. This preferred embodiment offers the further advantage that the current conducting device is constructed with adequate mechanical strength in the first area, or outside the cell housing, in particular to enable connection with a connecting device that is not associated with the converter cell, for example a busbar, a power band or a connection cable.

According to a second preferred embodiment of the current conducting device, the current collector is constructed with a contact surface. One or more of said electrode tabs with the same polarity are connected to the current collector electrically, particularly materially, inside the cell housing. Said contact surface is arranged essentially in a lateral surface of one of said housing sections or extends only slightly into the surrounding area. The contact surface is preferably furnished with a spring-loaded connecting device to ensure electrical connection. This preferred embodiment offers the advantage that the contact surface may be covered with an insulating adhesive strip for transport or storing the converter cell.

According to a third preferred embodiment of the current conducting device, the current collector is constructed in two parts and has an essentially plate-like, metal or metal-coated tab connecting section and the same kind of connector connecting section. At least one or more of said electrode tabs with the same polarity are connected electrically, particularly materially, to the tab connecting section inside the cell housing. The connector connecting section extends out of the cell housing, particularly through the second polymer material, into the external environment, particularly for connection with one of said connection devices. Both the tab connecting section and the connector connecting section are connected electrically, particularly materially to the same of said functional devices. The tab connecting section and/or the connector connecting section preferably each have a protrusion that extends particularly through one of said contacting recesses of the second bearing element, which are connected electrically, particularly materially, to the same of said functional devices.

The tab connecting section and the connector connecting section are not directly electrically connected to each other. The tab connecting section and the connector connecting section may be electrically interconnected with each other via said functional device, preferably via a functional element in the form of a semiconductor switch. This preferred embodiment offers the advantage that said cell current can be prevented, in particular in order to terminate a charging or discharging operation, by insulating the tab connecting section from the connector connecting section.

According to a fourth preferred embodiment of the current conducting device, the current collector is only constructed with said connector connecting section corresponding to the third preferred embodiment, without said tab connecting section. In this embodiment, at least one or more of said electrode tabs with the same polarity are connected electrically, particularly materially, with one of said functional devices inside the cell housing electrically, particularly materially, particularly through one of said contacting recesses in the second bearing element. The connector connecting section extends out of the cell housing, particularly through the second polymer material, into the surrounding area, particularly for connection with one of said connecting devices. The connector connecting section is connected in electrically conductive manner with the same one of said functional devices as the at least one or more of said electrode tabs. Each connector connecting section preferably has one protrusion, which extends particularly through one of said contacting recesses in the second bearing element.

The connector connecting section and the electrode tabs with the same polarity are not directly electrically connected to each other. The connector connecting section and the electrode tabs with the same polarity are electrically interconnectable with each other via the functional device, preferably via a functional element in the form of a semiconductor switch. This preferred embodiment offers the advantage that said cell current can be prevented, in particular in order to terminate a charging or discharging operation, by insulating the connector connecting section from said electrode tabs with the same polarity. This preferred embodiment offers the advantage of a simplified construction of the current conducting device.

According to a fifth preferred embodiment of the current conducting device, at least one or more of said electrode tabs with the same polarity are electrically, particularly materially connected to one of said functional devices inside the cell housing, particularly via one of said contacting recesses of the second bearing element. Said functional device has one of said pole contact areas.

The pole contact area and the electrode tabs with the same polarity are not directly electrically connected to each other. Said pole contact area and said electrode tabs with the same polarity are electrically interconnectable with each other via the functional device, preferably via a functional element in the form of a semiconductor switch. This preferred embodiment offers the advantage that said cell current can be prevented, in particular in order to terminate a charging or discharging operation, by insulating the connector connecting section from said electrode tabs with the same polarity. This preferred embodiment offers the advantage of a simplified construction of the current conducting device. This preferred embodiment offers the advantage that the contact surface may be covered with an insulating adhesive strip for transport or storing the converter cell.

The at least one functional device of the converter cell and of the first housing section is preferably arranged between the first bearing element and the second bearing element, and is particularly materially connected to the bearing elements at least in areas.

The first bearing element preferably has at least one or two of said pole contact recesses, which particularly make one or two of said pole contact areas of the functional device electrically accessible from the outside.

The second bearing element preferably has at least one or two of said pole contact recesses, which are arrange adjacent to one or two of said electrode connecting areas of the functional device. This variation offers the advantage that an exchange of electrons with the electrode assembly is enabled even without a first area of the current conducting device protruding into the outside.

According to a preferred refinement of the first housing section, the first bearing element has two pole contact recesses, the functional device has two pole contact areas with different polarity, the second bearing element has two contacting recesses and the functional device has two electrode connection areas with different polarity. This refinement offers the advantage that the second or third housing section may be constructed without a pole contact area, which serves particularly to reduce the associated manufacturing costs significantly.

A temperature probe or thermocouple is preferably integrated in the second area of the current conducting device, particularly in the current collector thereof. The feed lines to the temperature probe or thermocouple terminate in the peripheral area of the first housing section, particularly at two contact surfaces in the area of a recess in the second bearing element. Two connectors for the functional device are also arranged close to said recess and are electrically connected to the contact surfaces. This variation offers the advantage that it enables the temperature to be measured in the current conducting device.

The converter cell preferably has a housing assembly with the first housing section and with at least one or two of said current conducting devices with opposite polarity. Said housing assembly serves particularly to simplify the production of the converter cell. The first housing section has a particularly materially connected layered bond with the first bearing element, the at least one functional device and the second bearing element. The first housing section is also furnished with the second polymer material particularly in the peripheral area. A peripheral area of the first housing section is preferably at least partially surrounded by the second polymer material. The first housing section also includes the accommodation space that is designed to at least partly accommodate the electrode assembly. The at least one of said current conducting devices, particularly the current collector thereof, has said contacting area, which is arranged in the peripheral area of the first housing section, preferably in the second polymer material. The second bearing element has at least one or two of said contacting recesses in the contacting area of at least one or two of said current conducting devices. The contacting area is particularly electrically connected to the functional device, particularly to the electrode connecting area thereof, through the contacting recess. This preferred variation offers the advantage that the housing assembly may be prepared separately.

The electrode assembly is not installed in the accommodation space of said housing assembly until the assembly has been completed. This preferred variation offers the further advantage that thermal energy loads generated while the accommodation space is being created, during placement of the second polymer material on the first housing section and/or during the particularly material connection is created between the current conducting device and the first housing section was said housing assembly is being manufactured cannot cause the electrode assembly to become heated and/or to suffer accelerated aging.

At least one of said functional devices, particularly of the first housing section, is preferably furnished with said cell control device, at least one or two of said electrode connecting areas, and at least one or more of said sensors. The at least one sensor is designed to capture an operating parameter of the converter cell, particularly of the electrode assembly thereof, and to make it available to the cell control device.

For the purposes of the invention, an operating parameter is understood to be a parameter particularly of the converter cell, which in particular
allows a conclusion to be drawn regarding the existence of a desired or predetermined operating state of the converter cell and/or the electrode assembly thereof, and/or
allows a conclusion to be drawn regarding the existence of an unplanned or undesirable operating state of the converter cell and/or the electrode assembly thereof, and/or
may be determined by a measurement probe or sensor, preferably an electric voltage or an electric current, wherein the measurement probe provides a signal at least intermittently, and/or
may be processed by a control device, particularly a cell control device, in particular may be compared with a target value, in particular may be linked with another captured parameter, and/or
enables an indication to be obtained regarding the cell voltage, the cell current, that is to say the strength of the flow of electrical energy into the electrode assembly or out of the electrode assembly, the cell temperature, the internal pressure in the converter cell, the integrity of the converter cell, the release of a substance from the electrode assembly, the presence of a foreign substance particularly from the area outside the converter cell and/or the charge state, and/or
advises switching the converter cell to another operating state.

The cell control device is designed to control at least one operating process of the converter cell, particularly the charging and/or discharging of the electrode assembly. The cell control device preferably monitors an operating state of the converter cell. The cell control device preferably initiates the switching of the converter cell to a predetermined operating state. The cell control device preferably displays the state of the converter cell via a display device, particularly via at least one LED. This preferred variation offers the advantage that the cell control device is protected in its arrangement in the first housing section. This preferred variation offers the further advantage that the converter cell has its own cell control device for operating and/or monitoring the electrode assembly, which also remains on the converter cell when the converter cell is removed from a battery.

The cell control device is preferably designed to initiate the switch of the converter cell to a “safe” state, wherein the charge of the converter cell in the safe state is equal to not more than half the charging capacity, wherein particularly in the safe state the cell voltage is not more than 3 V. This preferred variation offers the advantage that the converter cell can be switched to the safe state of the converter cell even when it is outside the battery pack.

According to a first preferred refinement, the functional device is equipped with a first short-range radio device, which is call-connected to the cell control device. Said first short-range radio device is used particularly to ensure wireless communication with a higher level battery controller, particularly with the second short-range radio device thereof. The first short-range radio device is preferably configured to transmit a predetermined signal to a higher level battery controller in particular periodically. This refinement offers the advantage that the battery controller is able to include the added converter cell to the predetermined signal for supplying a consumer. This refinement offers the further advantage that the battery controller is able to isolate a converter cell after the predetermined signal is not received.

According to a further preferred refinement, the functional device has two cell control connectors, and the first bearing element has two recesses in the area of said cell control connectors. The converter cell may be connected to a data link or databus via the cell control connectors. This preferred refinement offers the advantage that the cell controller is able to communicate with the higher level battery controller via the two cell control connectors.

The converter cell is preferably designed to take up and/or deliver a charge of at least 3 Ampere hours [Ah], more preferably at least 5 Ah, yet more preferably at least 10 Ah, yet more preferably at least 20 Ah, yet more preferably at least 50 Ah, yet more preferably at least 100 Ah, yet more preferably at least 200 Ah, yet more preferably at most 500 Ah. This variation offers the advantage of an improved service life of the consumer that is supplied by the converter cell.

The converter cell is preferably designed to provide a current of at least 50 A, more preferably at least 100 A, more preferably at least 200 A, more preferably at least 500 A, more preferably at most 1000 A, particularly for at least one hour. This variation offers the advantage of improved performance by the consumer that is supplied by the converter cell.

The converter cell is preferably designed to provide an electrical voltage, particularly a terminal voltage of at least 1.2 V more preferably at least 1.5 V, more preferably at least 2 V, more preferably at least 2.5 V, more preferably at least 3 V, more preferably at least 3.5 V, more preferably at least 4 V, more preferably at least 4.5 V, more preferably at least 5 V, more preferably at least 5.5 V, more preferably at least 6 V, more preferably at least 6.5 V, more preferably at least 7 V, more preferably at most 7.5 V, particularly for at least one hour. The electrode assembly preferably includes lithium ions. This variation offers the advantage of improved energy density of the converter cell.

The converter cell may preferably be operated within a temperature range between −40° C. and 100° C., more preferably between −20° C. and 80° C., more preferably between −10° C. and 60° C., more preferably between 0° C. and 40° C., particularly for at least one hour. This variation offers the advantage of an installation and use of the converter cell with the fewest possible limitations for supplying a consumer, particularly a motor vehicle or a stationary system or machine.

The converter cell preferably has a gravimetric energy density of at least 50 Wh/kg, more preferably at least 100 Wh/kg, more preferably at least 200 Wh/kg, more preferably less than 500 Wh/kg. The electrode assembly preferably includes lithium ions. This variation offers the advantage of improved energy density of the converter cell.

According to a preferred embodiment, the converter cell is designed for installation in a motor vehicle having at least one electric motor. The converter cell is preferably designed to supply power to said electric motor. The converter cell is particularly preferably designed to supply power at least intermittently to an electric motor in a drivetrain of a hybrid or electric motor vehicle. This variation offers the advantage of improved power supply to the electric motor.

According to a further preferred embodiment, the converter cell is designed for use in a stationary battery, particularly in a buffer tank, as a device battery, an industrial battery or starter battery. The charge capacity of the converter cell for these applications is preferably at least 50 Ah. This variation offers the advantage of improved supply of power to a stationary consumer particularly fixed installation electric motor.

According to a first preferred embodiment, the at least one separator, which conducts electrons poorly or not at all, consists of a carrier that is at least partly substance-permeable. The carrier is preferably coated with an inorganic material at least on one side thereof. An organic material that preferably does not have the form of a non-woven fabric is preferably used as the at least partly substance-permeable carrier. The organic material, which is preferably a polymer and particularly preferably contains a polyethylene terephthalate (PET), is coated with an inorganic, preferably ion-conducting material, which is also preferably ion-conductive in a temperature range from −40° C. to 200° C. The inorganic material preferably contains at least compound from the group of oxides, phosphates, sulphates, titanates, silicates, and aluminosilicates with at least one of the elements Or, Al, Li, particularly preferably zirconium oxide. Zirconium oxide is particularly beneficial for the material integrity, nanoporosity and flexibility of the separator. The inorganic, ion-conductive material preferably includes particles having a largest diameter smaller than 100 nm. This embodiment offers the advantage that the durability of the electrode assembly at temperatures above 100° C. is improved. Such a separator is marketed in Germany for example by Evonik AG under the trade name “Separion”.

According to a second preferred embodiment, the at least one separator, which conducts electrons poorly or not at all, but is conductive for ions, is made at least mostly if not completely from a ceramic, preferably an oxide ceramic. This embodiment offers the advantage that the durability of the electrode assembly above 100° C. is improved.

### PREFERRED EMBODIMENTS OF THE CONVERTER CELL

A first preferred embodiment of the converter cell comprises said electrode assembly, a first and a second said current conducting devices with opposite polarity and said cell housing. The electrode assembly comprises a particularly rechargeable electrode flat winding, a particularly rechargeable electrode stack or converter assembly with at least one electrode each having a first and a second polarity.

The current conducting devices have at least one or more of said electrode tabs, wherein the at least one electrode tabper current conducting device is electrically connected to the current collector in the cell housing. The first current conducting device, particularly the electrode tabthereof, is electrically connected to the electrode with a first polarity. The second current conducting device, particularly the electrode tabthereof, is electrically connected to the electrode with a second polarity. Said current conducting devices also each have one said current collector, which preferably extend into the area outside of the converter cell, particularly for the purpose of simplifying electrical connection to a connecting device. The electrode tabs and the current collector of at least one said current conducting device are particularly materially connected.

The cell housing includes the first housing section. The first housing section includes the first bearing element, the second bearing element and at least one or more of said functional devices, each of which has at least one or more of said functional elements. Each bearing element is furnished with a first polymer material, which is particularly interfused with fibres. The first bearing element delimits the at least one of said functional devices with respect to the area outside the converter cell. The second bearing element delimits the at least one of said functional devices with respect to the electrode assembly of the converter cell. The at least one functional device is arranged between the first and the second bearing element. The first bearing element, and preferably also the second bearing element, is connected, particularly materially, at least in areas to at least one of said functional devices. The second bearing element is furnished with one or two said contacting recesses, through which the areas of the adjacent functional device are exposed with respect to the electrode assembly. The peripheral area of the first housing section is furnished with the second polymer material, which preferably encloses the peripheral area of the first housing section. The current collector of at least the first current conducting device is routed through the second polymer material. The current collector of the second current conducting device is preferably routed through the second polymer material. The second polymer material preferably provides a material and/or gas-tight connection between the peripheral area of the first housing section and the current collector of the first current conducting device, and preferably the also the current collector of the second current conducting device. The first housing section preferably has an accommodation space, which at least partially accommodates the electrode assembly.

The at least one functional device is operatively connected, particularly electrically connected, to the electrode assembly. The at least one functional device has one, preferably two said electrode connecting areas, which serve to ensure the electrical connection with the electrode assembly. The two current conducting devices are each furnished with one of said contacting areas, wherein the contacting areas serve to ensure the electrical connection with the at least one functional device, particularly via the electrode connecting areas thereof. The first electrode connecting area of the at least one functional device and the contacting area of the first current conducting device are electrically connected to each other, preferably with a material connection, particularly in the area of the first contacting recess. The second electrode connecting area of the at least one functional device is preferably electrically connected to the contacting area of the second current conducting device, preferably with a material connection, particularly in the area of the second contacting recess. The at least one functional device is preferably realised as an assembled, particularly flexible circuit board. Particularly preferably, the functional device includes said cell control device.

The cell housing further has a second housing section. The second housing section includes at least the first bearing element with a first polymer material that is particularly interfused with fibres. The first housing section and the second housing section together form the cell housing around the electrode assembly. The second housing section preferably contains the second polymer material in a peripheral area, which polymer material particularly preferably encloses the peripheral area of the second housing section. The current collector of the second current conducting device preferably passes through the second polymer material. The second polymer material preferably provides a material and/or gas-tight connection between the peripheral area of the second housing section and the current collector of the second current conducting device. The second housing section preferably has an accommodation space that at least partly accommodates the electrode assembly. The cell housing preferably surrounds the electrode assembly in such manner that a frictional force between the cell housing and the electrode assembly prevents undesirable relative movement thereof.

This preferred embodiment offers the advantages that
the functional device is protected by the first bearing element against harmful influences from the area surrounding the converter cell,
harmful consequences of vibrations on the functional device during operation are counteracted,
the functional device is retained essentially immovably in the cell housing,
the functional device remains on the converter cell particularly in the event of an accident,
the cell control device controls and monitors the functions of the converter cell, and particularly of the electrode assembly thereof, independently of a battery controller, particularly when the converter cell is not part of a battery.

According to a first preferred refinement of this preferred embodiment, the current collector of the first current conducting device is routed through the second polymer material of the first housing section and the current collector of the second current conducting device is routed through the second polymer material of the second housing section. This refinement offers the advantage that the first and second housing sections can be manufactured with identical production steps, so that production effort is reduced.

According to a second preferred refinement of this preferred embodiment, both current collectors are routed through the second polymer material of the first housing section. In addition, the accommodation space of the first housing section is dimensioned such that the electrode assembly may be completely accommodated therein. This refinement offers the advantage that the second housing section may be produced essentially without an accommodation space, so that production cost is reduced. This refinement offers the further advantage that after the electrode assembly is installed in the accommodation space the electrode tabs and the current collectors can be electrically connected more easily, particularly due to the improved accessibility.

According to a third preferred refinement of this preferred embodiment, the first and second housing sections are connected to one another via a hinged area. The hinged area extends along one delimiting edge each of the first housing section and the second housing section. The wall of the hinged area is preferably thinner than the areas of the housing sections that delimit the electrode assembly. The hinged area is particularly preferably realised as a foil hinge. This embodiment offers the advantage that the length of the edges of the cell housing that must be sealed is reduced. This preferred refinement may be combined with the first or second preferred refinements.

According to a fourth preferred refinement of this preferred embodiment, the first and second housing sections are separated by a frame. The housing sections are connected to the frame particularly in a material connection. The frame essentially comprises four frame elements, which are arranged relative to each other to form a rectangle. The frame delimits a space that is designed to accommodate the electrode assembly. The frame is preferably constructed from the second polymer material, particularly preferably essentially completely from the second polymer material. This preferred refinement offers the advantage that each of the housing sections can be formed without an accommodation space. According to a preferred refinement two of said current conducting devices extend at least partly through the frame and into the surrounding area. According to a further preferred refinement, at least one of said housing sections has one or two of said pole contact areas.

A second preferred embodiment of the converter cell is substantially the same as the first preferred embodiment, except that the cell housing is equipped with the third housing section instead of the second housing section.

The third housing section conducts heat more readily than the first housing section. The third housing section preferably contains a metal, particularly preferably aluminium and/or copper. The third housing section is in the shape of a plate. The third housing section has a first heat transfer area, with which the electrode assembly is in thermal contact and which the electrode assembly can exchange thermal energy particularly in order to cool the electrode assembly if its temperature is above a permissible maximum temperature. The second and first housing sections together form the cell housing that surrounds the electrode assembly.

The two current collectors are preferably routed through the second polymer material of the first housing section. The accommodation space of the first housing section is also dimensioned such that there is sufficient room to accommodate the electrode assembly entirely. This embodiment offers the further advantage that, after the electrode assembly has been fitted in the accommodation space it is easier to create the electrical connections with the electrode tabs and the current collectors, particularly due to improved accessibility.

This preferred embodiment offers the advantages that
the functional device is protected by the first bearing element against harmful influences from the area surrounding the converter cell,
harmful consequences of vibrations on the functional device during operation are counteracted,
the functional device is retained essentially immovably in the cell housing,
the functional device remains on the converter cell particularly in the event of an accident,
the cell control device controls and monitors the functions of the converter cell, and particularly of the electrode assembly thereof, independently of a battery controller, particularly when the converter cell is not part of a battery,
thermal energy can be exchanged with the electrode assembly via the third housing section,
accelerated aging of the electrode assembly can be prevented by dissipating heat into the third housing section.

A third preferred embodiment of the converter cell comprises said electrode assembly, first and second said current conducting devices with opposite polarities and said cell housing. The electrode assembly is constructed as an electrode flat winding or an electrode stack with at least one electrode for each of a first and a second polarity.

The current conducting devices each have one said contacting area and at least one or more said electrode tabs, wherein the contacting areas are used to make an electrical connection with the functional device particularly via the electrode connecting areas thereof. The first current conducting device, particularly the electrode tabthereof, is electrically connected to the electrode with a first polarity. The second current conducting device, particularly the electrode tabthereof, is electrically connected to the electrode with a second polarity.

The cell housing includes the first housing section. The first housing section includes the first bearing element, the second bearing element and at least one or more of said functional devices, each of which has at least one or more of said functional elements. Each bearing element is furnished with a first polymer material, which is particularly interfused with fibres. The first bearing element delimits the at least one of said functional devices with respect to the area outside the converter cell. The second bearing element delimits the at least one of said functional devices with respect to the electrode assembly of the converter cell. The at least one functional device is arranged between the first and the second bearing element. The first bearing element, and preferably also the second bearing element, is connected, particularly materially, at least in areas to at least one of said functional devices. The first bearing element is furnished with at least one or two of said pole contact recesses, each of which leaves an area of the adjacent functional device open to the area outside the converter cell. The second bearing element is furnished with one or two of said contacting recesses, through which areas of the adjacent functional device are exposed with respect to the electrode assembly. The peripheral area of the first housing section is furnished with the second polymer material, which encloses the peripheral area of the first housing section. The second polymer material also connects the peripheral area of the first housing section to the first current conducting device, and preferably the also the second current conducting device materially and/or in gas-tight manner. The first current conducting device, preferably the second current conducting device as well, extends out of the second polymer material and into the cell housing toward the electrode assembly. The first housing section preferably has an accommodation space, which at least partially accommodates the electrode assembly.

The at least one functional device is operatively connected, particularly electrically connected, to the electrode assembly. The at least one functional device has one, preferably two said electrode connecting areas, which serve to ensure the electrical connection with the electrode assembly. The two current conducting devices are each furnished with one of said contacting areas, wherein the contacting areas serve to ensure the electrical connection with the at least one functional device, particularly via the electrode connecting areas thereof. The first electrode connecting area of the at least one functional device and the contacting area of the first current conducting device are electrically connected to each other, preferably with a material connection, particularly in the area of the first contacting recess. The second electrode connecting area of the at least one functional device is preferably electrically connected to the contacting area of the second current conducting device, preferably with a material connection, particularly in the area of the second contacting recess. The at least one functional device is also furnished with one or two of said pole contact areas, each of which is exposed to the surrounding area by one of said pole contact recesses in the first bearing element. The pole contact areas of the at least one functional device are each electrically connected to the electrode connecting areas thereof. The functional device is preferably realised as an assembled, particularly flexible circuit board. Particularly preferably, the functional device has a cell control device.

The cell housing also has the second housing section. The second housing section includes said first bearing element, preferably said second bearing element, and preferably at least one of said functional devices. The first bearing element, and preferably the second bearing element as well, each have a first polymer material that is particularly interfused with fibres. The at least one functional device is preferably arranged between the first and second bearing elements. The bearing elements are preferably connected at least in areas to the at least one functional device, particularly with a material connection. The first bearing element is preferably furnished with one of said pole contact recesses, which leaves an area of the adjacent functional device exposed to the area outside the converter cell. The functional device is preferably furnished with one of said electrode connecting areas, which serves to ensure an electrical connection with the electrode assembly particularly via one of said contacting areas of the current conducting devices. The functional device is preferably furnished with one of said pole contact areas, is exposed to the outside environment by the pole contact recess of the first bearing element. The pole contact area of the functional device is preferably electrically connected to the electrode connecting area thereof. The second housing section contains the second polymer material in a peripheral area, and the polymer material preferably encloses the peripheral area of the second housing section. The second polymer material preferably connects the peripheral area of the second housing section and the second current conducting device with a material and/or gas-tight connection. The second housing section preferably has an accommodation space that at least partly accommodates the electrode assembly.

This preferred embodiment offers the advantages that
the functional device is protected by the first bearing element against harmful influences from the area surrounding the converter cell,
harmful consequences of vibrations on the functional device during operation are counteracted,
the functional device is retained essentially immovably in the cell housing,
the functional device remains on the converter cell particularly in the event of an accident,
each of the current conducting devices can be constructed without a current collector.

According to a first preferred refinement of this preferred embodiment, the at least one functional device of the first housing section has two said pole contact areas and two said electrode connecting areas, with opposite polarities in each case. The first bearing element of the first housing section has two said pole contact recesses. The second bearing element of the first housing section has two said contacting recesses. This preferred refinement offers the further advantage that the current conducting devices can be constructed without a first area.

According to a second preferred refinement of said preferred embodiment, the at least one functional device of the first housing section has one said pole contact area and one said electrode connecting area. The first bearing element of the first housing section has one of said pole contact recesses. The second bearing element of the first housing section has one of said contacting recesses. The at least one functional device of the second housing section also has one of said pole contact areas and one of said electrode connecting areas. The first bearing element of the second housing section has one of said pole contact recesses. The second bearing element of the second housing section has one of said contacting recesses. This preferred refinement offers the advantage that energy can be exchanged with the electrode assembly via the pole contact areas of the first and second housing sections. This preferred refinement offers the further advantage that the current conducting devices can be constructed without a first area.

Said housing sections are preferably connected via said hinged area or said frame, in the same way as in the third and fourth preferred refinements of the first preferred embodiment of the converter cell.

A fourth preferred embodiment is essentially the same as the first or second preferred embodiments, wherein the electrode assembly is realised as a converter assembly. At least one of said functional devices in said preferred embodiment has at least one, preferably two or three of said fluid passthroughs. A fluid feed that is not associated with the converter cell and is connected to this fluid passthrough particularly for the purpose of supplying or removing one of said process fluids. This fluid passthrough is preferably essentially of tubular construction and is connected materially and in gas-tight manner to the first base course. This fluid passthrough preferably extends out of the cell housing and into the area outside of the converter cell.

According to first preferred refinement of this embodiment, the converter assembly is in the form of a polymer electrolyte fuel cell. The membrane is proton-conductive. H₂ serves as the fuel and is passed to the negative electrode, furnished with a precious metal as the catalyst, particularly with Pt. After ionisation, the protons pass through the membrane to the positive electrode, where they come into contact with the oxidising agent. Water is created as the reactant.

According to a second preferred refinement of this embodiment, the converter assembly is characterised by the integration of a hydrogen reservoir and a miniaturised fuel cell in a single unit. In this case, no peripheral components such as pressure reducers, pressure regulators or hydrogen supply lines are needed. The hydrogen is fed to the fuel cell directly from the integrated reservoir. The quantity of the hydrogen that is fed to the fuel cell is controlled via the material properties of the surface of the hydrogen reservoir and via the contact surface between the hydrogen reservoir and the fuel cell. In order to construct the fuel cell entirely without active components, it is configured as a self-breathing fuel cell. This preferred refinement offers significant potential for miniaturisation.

According to a third preferred refinement of this embodiment, the converter assembly is constructed with an air cathode made from highly porous Al₂O₃, ZnO or SiC. The anode is made from compacted Zn powder, metal foam with Zn or ceramic loading, particularly SiC, with Zn fractions. The electrolyte and the separator are in the form of non-woven fabric or porous ceramic with a KOH content of 30%. This preferred refinement is particularly suitable for high operating temperatures.

Said housing sections are preferably connected via said hinged area or said frame, in same way as in the third and fourth preferred refinements of the first preferred embodiment of the converter cell.

A battery preferably includes at least two converter cells according to the invention or preferred embodiments thereof. The battery also has a battery controller and preferably a second short-range radio device. The second short-range radio device is preferably call-connected to one of said first short-range radio devices of said converter cells.

The second short-range radio device is particularly preferably designed to transmit a predetermined first signal periodically, to which a first short-range radio device replies with a predetermined signal. This variation offers the advantage that die operability of the converter cells in the battery can be queried with the short-range radio device.

The battery controller is particularly preferably designed such that upon receipt of a predetermined second signal from one of said first short-range radio devices in one of the converter cells via the second short-range radio device, it integrates said converter cell into the supply for a connected consumer. This variation offers the advantage that replacement of a converter cell is simplified.

Preferably, the at least two converter cells are constructed with one first and second layer area each with different wall thicknesses. These layer areas are coordinated with one another in such manner that at least one channel for a temperature control medium is formed between the first converter cell and the second converter cell, particularly between the cell housings thereof. Particularly preferably, the channel passes between one of said first layer areas of the first converter cell and of said second layer areas of the second converter cell. This variation offers the advantage that the temperature control medium can exchange heat with at least one of these two converter cells as it flows along the channel, particularly in order to transport heat away from at least one of the two converter cells.

A fifth preferred embodiment of the converter cell is essentially the same as the first or second preferred embodiment, except that one or two of said current conducting devices are constructed as described in No. 2, wherein one or more of said electrode tabs are electrically connected to said functional device, or as described in No. 3, wherein the current collector is constructed in two parts with said tab connecting section and said connector connecting section. This preferred embodiment offers the advantage that the cell current may be interrupted via the functional device.

According to a preferred refinement of this preferred embodiment, at least one semiconductor switch of said functional device, preferably a field effect transistor, is integrated between the tab connecting section and the connector connecting section. This semiconductor switch is controllable by the cell control device. The tab connecting section and the connector connecting section are realised as a metal plate. Preferably, certain areas of the functional device are constructed so as to be electrically insulating and it is disposed between the tab connecting section and the connector connecting section. The tab connecting section and/or the connector connecting section preferably has/have a recess for the at least one semiconductor switch. The semiconductor switch lies flush against the tab connecting section and/or the connector connecting section for improved thermal conductivity. This preferred refinement offers the advantage that this cell current can be bound by means of the functional device. This preferred refinement offers the advantage that the effort required to cool the semiconductor switch is reduced.

A sixth preferred embodiment of the converter cell is essentially the same as the third preferred embodiment, except that one or two of said current conducting devices are constructed as described in the fifth preferred embodiment of the current conducting device. In this fifth preferred embodiment of the current conducting device, one of said functional devices is furnished with one of said pole contact areas, is electrically connected to one or more of said electrode tabs, and is configured to enable electrical interconnection of the pole contact area with said electrode tabs, particularly with a semiconductor switch. This preferred embodiment offers the advantage that the cell current may be interrupted via the functional device.

### Method for Producing a Converter Cell

The following is a description of a method according to the invention for producing an electrochemical energy conversion device, hereinafter also called a converter cell. In particular, the converter cell is constructed as described in the preceding. The converter cell that is produced in accordance with the inventive method has one of said electrode assemblies, at least one or two of said current conducting devices and one of said cell housings with one of said first housing sections, preferably also with one of said second or third housing sections. The electrode assembly has at least two electrodes with opposite polarity. At least two of said current conducting devices are connected to one electrode of opposite polarity each. At least one or two of said current conducting devices preferably are furnished with at least one or more electrode tab, and particularly preferably one current collector each. Preferably, at least one or two of said current conducting devices have one contacting area each. The first housing section has a first bearing element and at least one or more of said functional devices, each having at least one or more of said functional elements. The first bearing element faces towards the area surrounding the converter cell. The first bearing element includes a first polymer material, which is particularly interfused with fibres. The at least one functional device is particularly materially connected to the first bearing element at least in areas thereof. At least one of these functional devices is operatively connected, preferably electrically connected to the electrode assembly. The first housing section preferably includes the second bearing element, which is arranged between the functional devices and the electrode assembly, and is particularly preferably connected to one of said functional devices, particularly with a material connection. The first housing section preferably includes a second polymer material in a peripheral area thereof. The production method according to the invention is characterised by at least one of the following steps:
(S1) Producing at least one or more of said functional devices, each of which having at least one or more of said functional elements, wherein preferably at least one or two of said functional elements is realised as an electrode connecting area or a pole contact area, preferably subsequently transporting at least one or more of said functional devices to a first storage location,
(S1′) Producing at least one or more of said functional devices, each of which having at least one or more of said functional elements, wherein preferably at least one or two of said functional elements is realised as an electrode connecting area or a pole contact area, wherein the following is incorporated in at least one of said functional devices: a foam, a cavity structure, particularly a honeycomb structure, at least one cavity for a temperature control medium, a filler with phase transition capability and/or a chemically reactive filler, preferably subsequently transporting at least one or more of said functional devices to a first storage location,
(S1″) Producing at least one or more of said functional devices, each of which having at least one or more of said functional elements, wherein preferably at least one or two of said functional elements is realised as an electrode connecting area or a pole contact area, wherein at least one or more of said functional devices is produced with a first layer area having a first wall thickness, and with a second layer area having a second wall thickness, wherein the fraction resulting from dividing the second wall thickness by the first wall thickness is equal to a predetermined value less than 1, the first layer area particularly preferably has a lower density than the second layer area, preferably subsequent transport of at least one or more of said functional devices to a first storage location,
(S2) Providing, preferably from a second storage location, of one of said first bearing elements, which has a first polymer material, particularly interfused with fibres, and which is preferably furnished with one or two of said pole contact recesses, wherein one or two of said pole contact recesses is each adjacent to one of said pole contact areas, particularly after step S1,
(S2′) Placing one of said first bearing elements on top of another of said first bearing elements, particularly after step S2,
(S3) Placing at least one or more of said functional devices or functional assemblies, preferably from the first storage location on top of the first bearing element or another of said functional devices, wherein preferably at least one assembled, particularly flexible circuit board is placed on top of the first bearing element as the functional device, wherein the circuit board particularly preferably includes the functional element according to the first preferred variation of the functional device, particularly after step S2,
(S4) Making particularly material connections between the first bearing element and at least one of said functional devices, preferably under the effect of heat, preferably by means of an isotactic or continuous press, on which a layered bond is formed, particularly after step S3,
(S5) Placing a second bearing element on top of one of said functional devices, preferably from a third storage location, wherein the second bearing element has a first polymer material, particularly interfused with fibres, wherein the second bearing element preferably has one or two contacting recesses, particularly after step S3
(S6) Connecting the second bearing element to one of said functional devices, particularly to the adjacent functional device, preferably under the effect of heat, preferably by means of an isotactic or continuous press, particularly after step S5,
(S7) Storing the layered bond in a fourth storage location particularly after step S4,
(S8) Removing the layered bond particularly from the fourth storage location, wherein the layered bond includes at least the first bearing element, one or more of said functional devices, each of which having at least one or more of said functional elements and preferably the second bearing element, particularly after step S7,
(S9) Cutting one essentially flat moulded blank to length from the layered bond, preferably with a separating tool, particularly after step S8,
(S10) Heating the essentially flat moulded blank, preferably to a working temperature, which is at least equivalent to the softening temperature of the first polymer material of the first bearing element, particularly in the processing device, particularly after step S9,
(S11) Feeding the essentially flat moulded blank into a processing device, particularly a moulding device, particularly after step S10,
(S12) Inserting at least one or more of said current conducting devices, preferably inserting at least one or more of said current collectors, in the processing device, particularly in the moulding tool, particularly in addition to the essentially flat moulded blank, particularly after step S11,
(S13) Forming an accommodation space for the electrode assembly in the moulded blank, particularly in the processing device, particularly by deforming the particularly heated moulded blank with a body, wherein the accommodation space is adapted to the shape of the electrode assembly, which preferably has essentially the same shape as the electrode assembly, which is created particularly preferably by closing the moulding tool, particularly after step S12,
(S14) Adding a particularly readily flowable second polymer material to the moulded blank in the processing device, particularly in the moulding tool, preferably under the effect of heat and preferably with a pressure differential with respect to the ambient air pressure, wherein the second polymer material is arranged in the peripheral area of the moulded blank, particularly at a working temperature that is at least equivalent to the softening temperature of the second polymer material, wherein preferably one each of said contacting areas of at least one or two of said current conducting devices remains free, particularly after one of steps S10, S11, S12 or S13,
(S15) Solidifying the deformed moulded blank, preferably by cooling to a removal temperature that is particularly lower than the softening temperature of the first polymer material, which is particularly lower than the softening temperature of the second polymer material, particularly after step S14,
(S16) Removing the particularly deformed moulded blank, hereinafter also called the first housing section, from the processing device, particularly at a removal temperature that is lower than the softening temperature of the first polymer material, particularly after one of steps S14 or S15,

(S17) Supplying the first housing section or the particularly deformed moulded blank, preferably in a processing device, which serves particularly to form the cell housing around the electrode assembly, particularly after step S16,
(S18) Creating an electrical, particularly material connection between at least one or more of said electrode tabs with at least one or more of said electrodes of the electrode assembly, particularly by a joining process, preferably by a friction welding process, particularly preferably by ultrasonic welding, particularly after step S17 or S19,
(S19) Placing the electrode assembly, which preferably has at least one or more of said electrode tabs, with the first housing section, preferably in the processing device, particularly placing the electrode assembly in the accommodation space of the first housing section, particularly after step S17,
(S20) Creating electrical connection between the electrode assembly with at least one or more of said current conducting devices, particularly in a joining process, preferably by a friction welding process, particularly preferably by ultrasonic welding, particularly after step S19,
(S21) Creating electrical connection between one or more of said electrode tabs and one of said current collectors, which belong to the same current conducting device, particularly in a joining process, preferably by a friction welding process, particularly preferably by ultrasonic welding, particularly after step S19,
(S22) Creating electrical connection between the contacting area of at least one or more of said current conducting devices and at least one or more of said electrode connecting areas of at least one of said functional devices of the first housing section, particularly in the area of one of said contacting recesses of the second bearing element of the first housing section, a joining process, preferably by a friction welding process, particularly preferably by ultrasonic welding, particularly after step S11, particularly before step S26,
(S23) Mating the second housing section with the first housing section, wherein preferably the second housing section has the second polymer material in a peripheral area thereof, particularly after step S22,
(S24) Mating the third housing section with the first housing section, wherein preferably a first heat transfer area of the third housing section is arranged adjacently to the electrode assembly, particularly preferably is brought into thermal contact with the electrode assembly, particularly after step S22,
(S25) Heating particularly the peripheral area of the particularly first housing section to a working temperature, which is at least equivalent to the softening temperature of the second polymer material,
(S26) Creating particularly material connection between the second housing section or the third housing section and the first housing section, particularly at a working temperature, is at least equivalent to the softening temperature of the second polymer material, wherein preferably a peripheral area of first housing section is connected to second housing section or to the third housing section, particularly after step S25,
(S26′) Creating particularly material connection between the second housing section or the third housing section and the first housing section, particularly using a sealing and/or bonding material, wherein preferably a peripheral area of the first housing section is connected to the second housing section or the third housing section, particularly after step S25,
(S26″) Creating particularly material connection between the second housing section or the third housing section and the first housing section, preferably with introduction of a particularly readily flowable second polymer material, preferably under the effect of heat and with a pressure differential with respect to the area surrounding the processing device, particularly into the moulding tool, wherein the second polymer material is arranged in the peripheral area of at least one of the housing sections, particularly at a temperature that is at least equivalent to the softening temperature of the second polymer material, wherein preferably one each of said contacting areas of at least one or two of said current conducting devices remains free, wherein preferably a peripheral area of the first housing section is connected to the second housing section or the third housing section, particularly after step S25,
(S27) Joining a plurality of said functional elements in one of said functional devices, so that particularly a functional assembly is formed, particularly before step S3,
(S28) Lowering the air pressure in the area surrounding the first housing section, particularly before step S26, whereupon the higher normal pressure in the area around the cell housing closed after step S26 causes a frictional force between the cell housing and the electrode assembly, which counteracts an undesirable relative movement between the cell housing and the electrode assembly.

For the purposes of the invention, a pressure differential relative to the area surrounding the processing device in step S26″ is understood to mean that when the second polymer material is introduced into the processing device the area surrounding the processing device has a higher static pressure than the static pressure in the processing device. According to a preferred variation of step S26″, the second polymer material is exposed to an overpressure relative to the area surrounding the processing device. According to a further preferred variation of step S26″, an underpressure relative to the area surrounding the processing device exists in the area of the housing sections inserted into the processing device. Both pressure differentials are used for feeding the second polymer material into the processing device. Both variations offer the advantage that the filling of areas of the processing device intended for the second polymer material during connection of the inserted housing parts is improved.

The production method according to the invention offers the advantage that the cell housing or the first housing section thereof may be produced with a predetermined stiffness and/or a predetermined capacity to absorb energy with regard to a foreign body from the surrounding area impinging on the converter cell, whereby particularly the mechanical resistance of the converter cell is improved. For this purpose step S2 is carried out multiple times before step S4, whereupon a plurality of first support elements are connected to the functional device to form a layered bond or moulded blank.

The production method according to the invention offers the advantage that the cell housing or the first housing section thereof, which within the operating temperature range has a predetermined stiffness and/or a predetermined capacity to absorb energy with regard to a foreign body from the surrounding area impinging on the converter cell, may be produced at the working temperature with reduced energy consumption.

The production method according to the invention offers the advantage that the first bearing element improves the solidarity of the functional device, with the result that the resistance strength of the converter cell with respect to vibrations and the ability of the converter cell in the event of vibrations is improved.

The production method according to the invention offers the advantage that particularly in contrast to converter cells with a foil-type cell housing, separate stiffening components are not required.

The production method according to the invention offers the advantage that after forming the functional device and/or the layered bond and/or the first housing section the subsequent production steps are simplified. In this way, production costs are saved. The production method according to the invention offers the further advantage that the yield and quality of the production are improved.

The production method according to the invention offers the advantage that the cell housing is adaptable easily and inexpensively to electrode assemblies that have various charge capacities, particularly if production of the accommodation space in the first housing section can be delayed until immediately before the electrode assembly is placed in it. In this way storage costs may be reduced.

### Preferred Variations of the Previously Described Method According to the Invention for Producing a Converter Cell

A first preferred variation of the previously described method according to the invention for producing a converter cell, particularly for closing the cell housing around the electrode assembly, is characterised by the steps:
S17, S19, S20, S23 and S26, wherein the cell housing has one of these second housing sections, or
S17, S19, S20, S24 and S26, wherein the cell housing has one of these third housing sections.

This preferred variation of the method offers the advantage that at least one or more of said functional devices of the first housing section is/are arranged inside the cell housings and particularly are protected.

The method preferably also includes step S25. This preferred variation offers the advantage that the material connection between the warmed peripheral area and the second polymer material is improved.

step S26 is preferably replaced by step S26′. This preferred variation offers the advantage that the connection of these housing sections may be carried out at a temperature lower than the softening temperature of the first or second polymer materials, particularly preferably at room temperature, so that energy may be conserved.

Step S26 is preferably replaced by step S26″. This preferred variation offers the advantage that the filling of areas of the processing device intended for the second polymer material when the inserted housing sections are connected is improved.

A second preferred variation of the previously described method according to the invention for producing a converter cell, particularly for producing the first housing section, is characterised by steps: S11, S12, S14, S15, S16. This variation of the method preferably includes step S10 for heating up the moulded blank. This variation of the method preferably includes step S13 for creating the accommodation space. This preferred variation of the method offers the advantage that at least one or more of said current conducting devices is/are enclosed by the second polymer material, particularly in gas-tight manner, so that an exchange of substances between the interior space of the cell housing and the area outside the converter cell is prevented.

A third preferred variation of the previously described method according to the invention for producing a converter cell, particularly for producing a layered bond, wherein the layered bond includes the first bearing element, at least one or more of said functional devices and preferably the second bearing element, is characterised by steps: S2, S3, S4. This preferred variation of the method offers the advantage that a particularly material connection is created between the first bearing element and at least one of these functional devices, such that the solidarity of this functional device is improved, particularly in the event of impacts. Preferably in step S3 at least one assembled, particularly flexible circuit board is placed on the first bearing element as a functional device or functional assembly. This circuit board includes the functional elements according to the first preferred variation of the functional device. This preferred variation of the method offers the advantage that many functions for controlling or monitoring the electrode assembly may be carried out in the functional device that is connected to the first bearing element or is particularly an unlosable part of the cell housing.

This variation of the method preferably also includes step S2′ particularly after step S2. In this case, two first base courses are laid one on top of the other. This preferred variation offers the advantage that the wall thickness of the layered bond is increased, so that improved mechanical protection of an adjacent functional device is achieved.

This variation of the method preferably also includes steps S5 and S6. Particularly preferably, step S5 is carried out before step S4 and S6, which are carried out simultaneously. This preferred variation offers the advantage that the housing section is stiffened with at least one of said second bearing elements. This preferred variation offers the advantage that this functional device is electrically insulated with respect to the electrode assembly by this second bearing element.

This variation of the method preferably also includes one of steps S1, S1′ or S1″ particularly before step S2, particularly preferably with step S27. This preferred variation offers the advantage that the production of the functional device as well immediately beforehand saves storage costs.

According to preferred refinement of this preferred variation, the layered bond is produced with differing wall thicknesses. In this context, areas are produced for the first housing section, the second housing section and for a hinged area. The hinged area is produced with a thinner wall thickness than the areas for the housing sections and preferably without a functional device, preferably in that the areas for the housing sections receive additional base courses, or the hinged area only has one of these first base courses. The hinged area is arranged between the area for the first housing section and the area for the second housing section. Subsequently, the moulded blank is cut to length in such manner that it has said area for the first housing part at a first end thereof, said area for the second housing section at the opposite end thereof, and the hinged area between said two ends. This refinement offers the advantage that the length of the edges of the particularly cuboid cell housing to be sealed is reduced.

In order to close the cell housing or when connecting the first housing section with the second housing section, the hinged area is brought to a working temperature above the softening temperature of the first polymer material and bent in such manner that the area for the first housing section is opposite the area for the second housing section. Then, particularly after the housing sections have been connected around the electrode assembly, the hinged area is brought to a removal temperature, particularly below the softening temperature of the first polymer material.

A fourth preferred variation of the previously described method according to the invention for producing a converter cell, particularly for producing the first preferred refinement of the first preferred embodiment of the converter cell, is characterized by the steps:
S11, wherein one of said moulded blanks is introduced into a processing device with one of said functional devices, wherein said functional device has at least one of said electrode connecting areas,
S12, wherein one or preferably two of said current conducting devices or the current collectors thereof are added to said moulded blank in the moulding tool and are arranged there in the peripheral area of the moulded blank or the future first housing section,
preferably S22, wherein at least one of said contacting areas of one of said current conducting devices or one of said current collectors is electrically connected to at least one of said electrode connecting areas of the functional device,
S10, S13 and S14, wherein preferably S10 is carried out before S13, S13 is preferably carried out simultaneously with S14, whereupon an accommodation space for the electrode assembly is created in the moulded blank and second polymer material is arranged in the peripheral area of the moulded blank in such manner that the inserted current conducting devices or the current collectors thereof are enclosed by the second polymer material, particularly in gas-tight manner,
S15, whereupon the softened first polymer material of the first bearing element hardens again and the resulting first housing section can be removed from the moulding tool,
S18, for equipping the electrode assembly with at least one or more said electrode tabs, wherein the electrode tabs are connected to at least one of said electrodes with a first polarity or to at least one of said electrodes with a second polarity,
S17 and S19, with which the electrode assembly is added to the first housing section provided in the processing device, preferably arranged in the accommodation space of the first housing section,
S21, wherein said electrode tabs that are connected to said electrodes with first polarity, and said electrode tabs that are connected to said electrodes with second polarity are electrically connected to various current collectors, particularly via a joining process,
S23, wherein the second housing section is added to the first housing section and the electrode assembly in the processing device, wherein at least one of said peripheral areas of the first housing section and at least one of said peripheral areas of the second housing section are arranged adjacent to each other,
preferably S25, wherein particularly the peripheral area of particularly the first housing section is heated to a working temperature that is at least equivalent to the softening temperature of the second polymer material,
S26, wherein particularly the peripheral areas, preferably the second polymer materials of the first housing section and of the second housing section are connected to each other particularly by a material connection, particularly at a working temperature that is at least equivalent to the softening temperature of the second polymer material.

Further advantages, features and application possibilities of the present invention will be evident from the following description in conjunction with the figures, in which:
schematically shows details of a preferred embodiment of an electrochemical energy converter device according to the invention,
schematically shows two different layered bonds for first housing sections, schematically shows cross sections through first housing sections with various functional elements and first and second layer courses,
is a schematic view of a first housing section having first and second layer courses,
is a schematic view of a cross section through a first housing section with a metal insert,
is a schematic view of a cross section through a preferred embodiment of a converter cell,
schematically shows a processing device for producing a layered bond for a first housing section,
schematically shows a processing device for producing a layered bond for a certain embodiment of a first housing section, wherein one of said functional devices is represented as an assembled, flexible circuit board,
schematically shows the cutting to length of moulded blanks from a prepared layered bond,
schematically shows the production of a first housing section from a moulded blank with the addition of a seconds polymer material in the peripheral area, with formation of an accommodation space for an electrode assembly, with over moulding of current collectors and from the peripheral area of the moulded blank, in a processing device,
various views and cross sections of a first housing section with accommodation space,
schematically shows a converter cell with a two-part cell housing, wherein the first housing section is shaped like a cup and the second housing section is shaped like a cover,
schematically shows a converter cell with a two-part cell housing, wherein the housing sections are kept apart by a frame made from the second polymer material
schematically shows other preferred embodiments of converter cells, each having a two-part cell housing and each having two current collector, which extend into the area surrounding the converter cell,
schematically shows other preferred embodiments of converter cells, each having a two-part cell housing and each having current conducting devices, which are each essentially terminated by a shell surface of the cell housing,
schematically shows other preferred embodiments of converter cells, each having a two-part cell housing, each with a converter assembly and two fluid passthroughs,
schematically shows a cross section through a first housing section with a two-part current collector according to a preferred embodiment of the converter cell, particularly according to the fifth preferred embodiment of the converter cell,
schematically shows a detail of a current conducting device of another embodiment of a converter cell according to the fifth preferred embodiment.

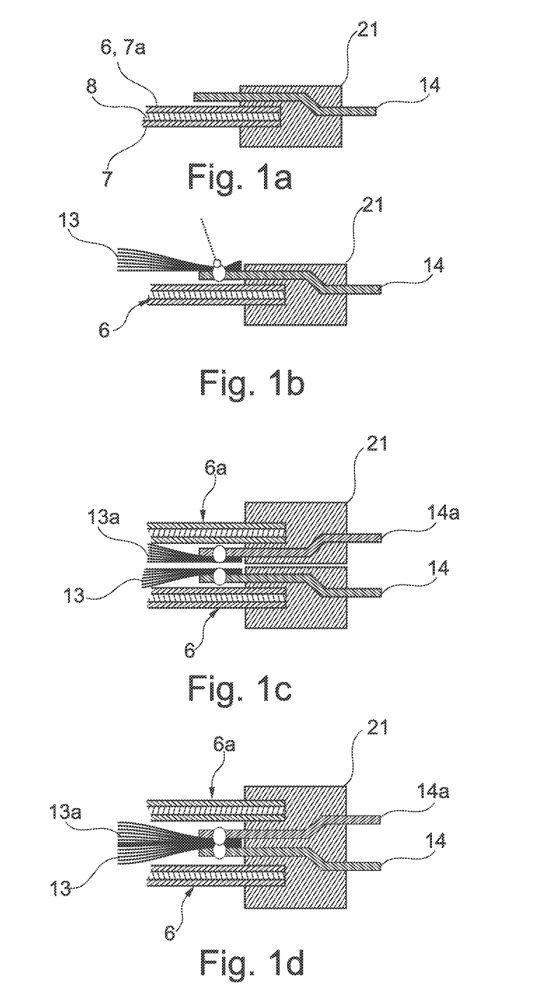

FIGS. 1a to 1d schematically show details of a preferred embodiment of an electrochemical energy converter device according to the invention and converter cell 1 with a first housing section 6. First bearing element 7 and second Bearing element 7a are advantageously constructed as base courses.

FIG. 1a shows that first housing section 6 is over moulded with a second polymer material 21 in a peripheral area. A current collector 14 is over moulded by second polymer material 21, particularly in gas-tight manner, and particularly connected essentially immovably to first housing section 6. First housing section 6 has first bearing element 7, second bearing element 7a and a functional device 8, wherein functional device 8 separates bearing elements 7, 7a.

FIG. 1b shows that electrode tabs 13 are welded to current collector 14. Electrode tabs 13 are also connected electrically, particularly materially to electrodes with a first polarity of an electrode assembly, not shown. This electrical connection is created after the electrode assembly, not shown, has been inserted in first housing section 6 and before the cell housing is closed.

FIG. 1c shows first housing section 6 and a second housing section 6a, the peripheral areas of which are each overmoulded with second polymer material 21. Current collectors 14, 14a are each connected to one of the housing sections 6, 6a by second polymer materials 21. Groups of electrode tabs 13, 3a are welded to current collectors 14, 14a. These groups of electrode tabs 13, 13a are electrically connected to electrode with opposite polarity of the same electrode assembly, not shown. Thus first current collector 14 has a different polarity from second current collector 14a. The cell housing is not yet closed.

FIG. 1d shows schematically a detail of converter cell 1 after cell housing 5 has been closed by material connection of first housing section 6 with second housing section 6a. In this context, second polymer materials 21 of the peripheral areas of housing sections 6, 6a are fused together. Current collectors 14, 14a protrude out of cell housing 5. Current collectors 14, 14a also extend inside cell housing 5.

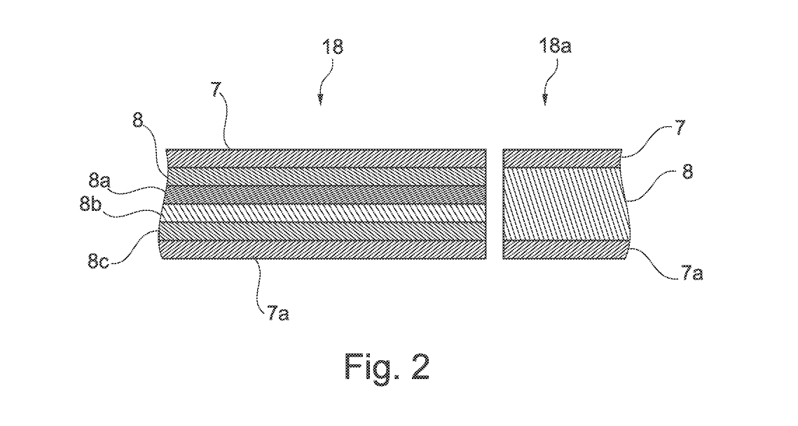

FIG. 2 shows schematically two different layered bonds 18, 18a for a first housing section. First bearing element 7 and second bearing element 7a are advantageously realised as base courses.

Layered bond 18 has two bearing elements 7, 7a, which surround or enclose four functional devices 8, 8a, 8b, 8c. The individual functional devices fulfil various tasks and to this end have different functional elements. Second bearing element 7a has an arrangement of recesses or holes that enable a substance, particularly from the electrode assembly, not shown, to pass through to fourth functional device 8c. Fourth functional device 8c has a pressure sensor, a thermocouple and a sensor for hydrogen fluoride, wherein the sensors are not shown. Third functional device 8b isolates second functional device 8a chemically and electrically from the electrical assembly. However, third functional device 8b has functional element for exchanging signals between second functional device 8a and said sensors. Second functional device 8a has a cell control device, not shown, that processes signals from said sensors and control the operation of the electrode assembly, which is also not shown. First functional device 8 is realised as a cotton sheet with alum as a flame-retardant filler and serves to protect second functional device 8a, which is beneath it.

Layered bond 18a has only one functional device 8. In this case, the pressure sensor, thermocouple and cell control device are part of the same functional device 8.

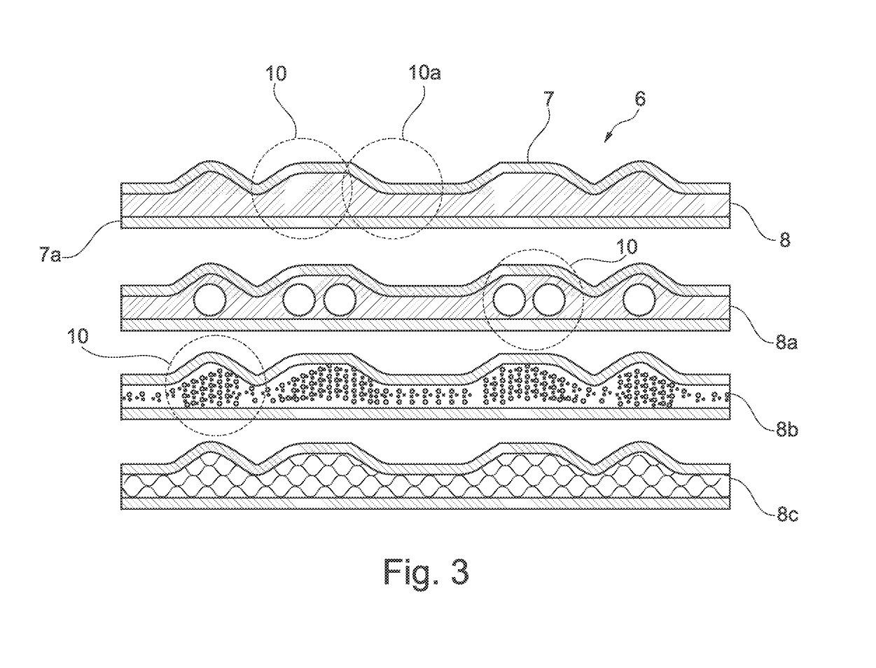

FIG. 3 shows schematic cross sections through different variations of first housing section 6 with various functional devices 8, 8a, 8b, 8c and first and second layer areas 10, 10a. Functional device 8 is surrounded by first bearing element 7 and second bearing element 7a. First bearing element 7 and second bearing element 7a are advantageously realised as base courses. Functional device 8 has two layer areas 10, 10a, wherein the first layer area 10 has greater wall thickness than second layer area 10a. Functional device 8a has multiple first layer areas 10, in which channels extend for transporting a temperature control medium. Functional device 8b has multiple first layer areas 10, which are filled with a foam. For this purpose, functional device 8a is filled with an expandable filler, which forms cavities when an activation energy is applied. Functional device 8c has a cavity structure, particularly a honeycomb structure. which serves to reduce weight while increasing the stiffness of first housing section 6.

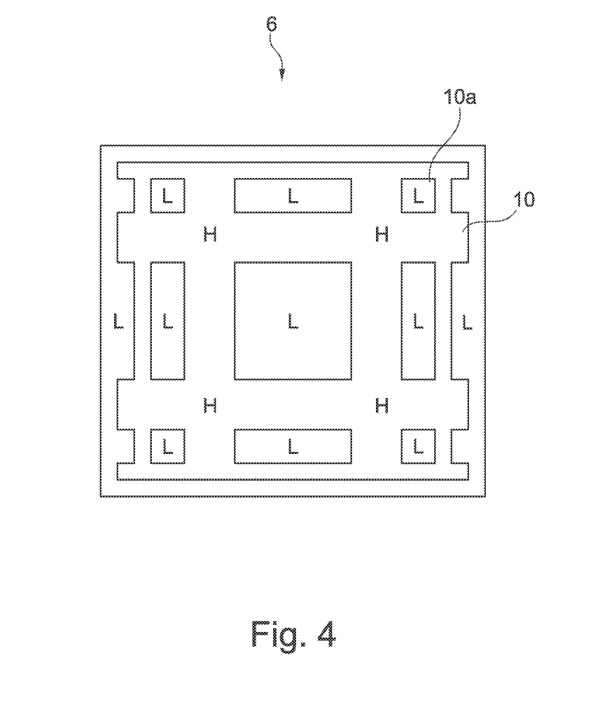

FIG. 4 is a schematic view of a first housing section 6 with first layer areas 10 and second layer areas 10a of the functional device. The first layer areas 10, also marked with the letter “H” have a greater wall thickness than second layer areas 10a, also marked with the letter “L”. First bearing element 7 and second bearing element 7a are advantageously in the form of base courses.

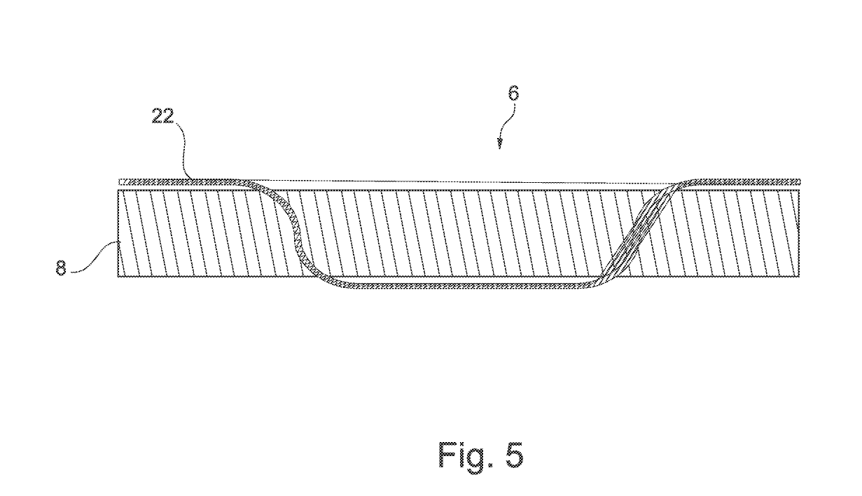

FIG. 5 is a schematic view of a cross section through a first housing section 6 with a particularly metal insert 22, which extends both inside functional device 8 and outside this functional device. For the purpose of simplicity, the adjacent bearing elements are not shown. Insert 22 serves to stiffen first housing section 6, particularly to increase the stiffness of first housing section 6. Insert 22 is profiled for increased stiffness.

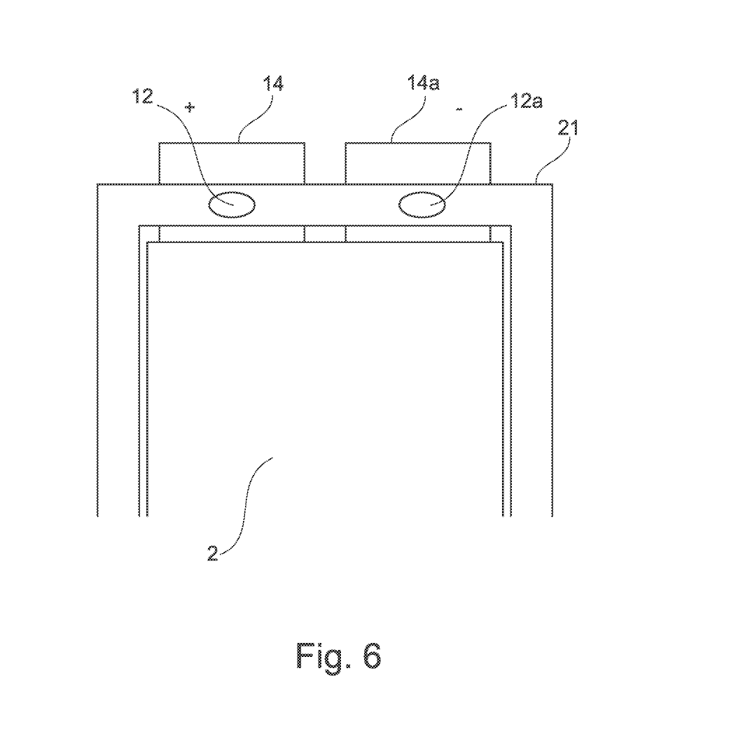

FIG. 6 is a schematic view of a cross section through a preferred embodiment of a converter cell. An electrode assembly 2 is inserted in a first housing section and connected electrically to current collector 14, 14a. Not shown are the electrode tabs, which form the electrical connection between a current collector 14, 14a and an electrode of electrode assembly 2. Both current collectors 14, 14a have contacting areas 12, 12a. Of first housing section only second polymer material 21 is shown. Bearing elements and functional devices are not shown so that contacting areas 12, 12a may be more clearly discernible. Contacting areas 12, 12a extend from second polymer material 21 towards the functional device, not shown. Contacting areas 12, 12a provide electrical connection, particularly for the supply of power to the functional device that is not shown.

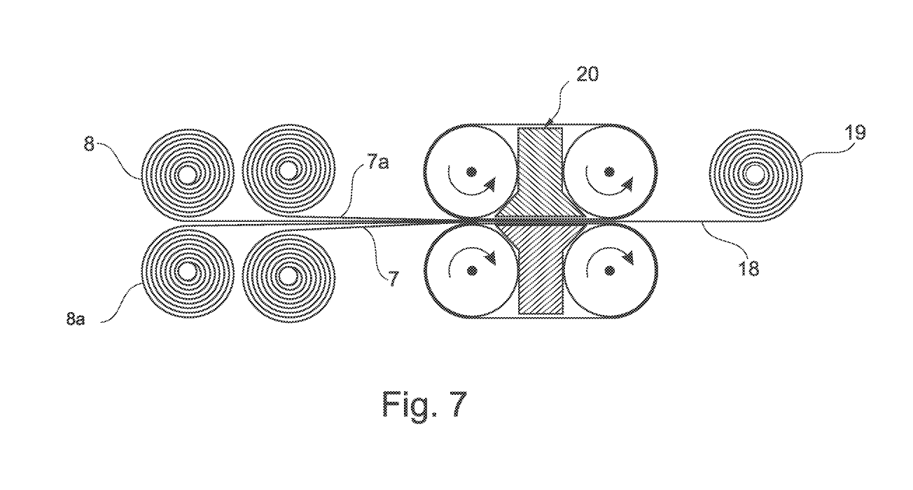

FIG. 7 is a schematic view of a processing device 2 for producing a layered bond 18 for a first housing section. First bearing element 7, second bearing element 7a and two functional devices 8, 8a are removed from various storage facilities. First bearing element 7 and second bearing element 7a have the form of base courses. These layers are forwarded to processing device 20, which in this case is a double belt press 20. Particularly under the effect of heat, the layers that are laid on top of one another are bonded together in double band press 20 to form a layered bond 18. Layered bond 18 is transported to storage facility 19.

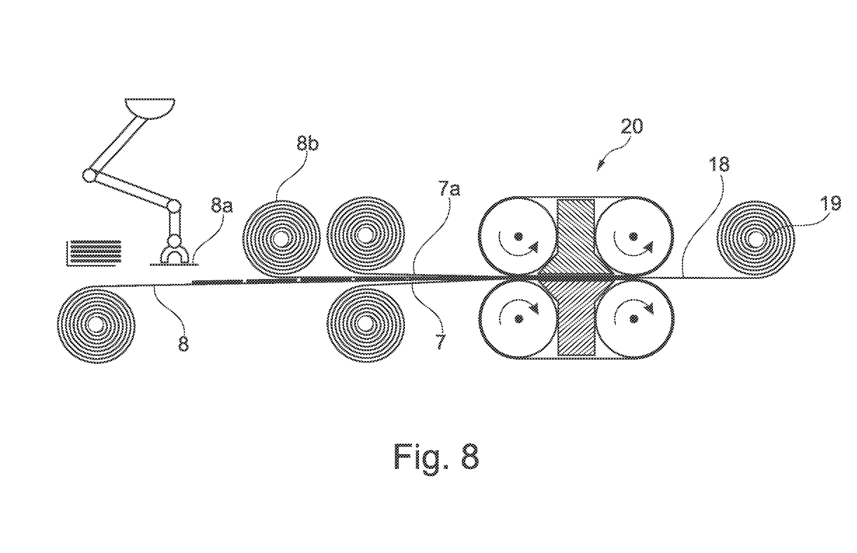

FIG. 8 is a schematic view of a processing device 20 for producing a layered bond 18 for a preferred embodiment of a first housing section with a plurality of functional devices, wherein one of these functional devices is an assembled, flexible circuit board 8a. First, the first functional device 8 is processed. Circuit boards 8a are deposited individually on top of first functional device 8 by a gripper, preferably with a minimum separation between two circuit boards. A further functional device 8b and two bearing elements 7, 7a are processed. First bearing element 7 and second bearing element 7a are advantageously in the form of base courses. Circuit board 8a is enclosed by bearing elements 7, 7a before the layers are introduced into double band press 20. In double band press 20, layered bond 18 is produced, particularly under the effect of heat. Layered bond 18 is taken to storage facility 19.

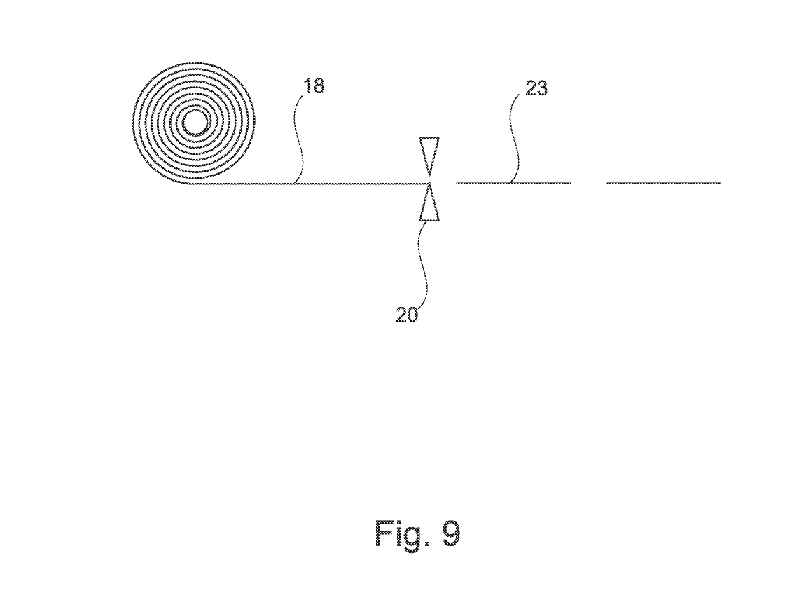

FIG. 9 is a schematic view of the process of cutting moulded blanks 23 to length from a prepared layered bond 18, particularly by means of a separating device 20. If one of the functional devices is in the form of a circuit board, layered bond 18 is separated between two such circuit boards.

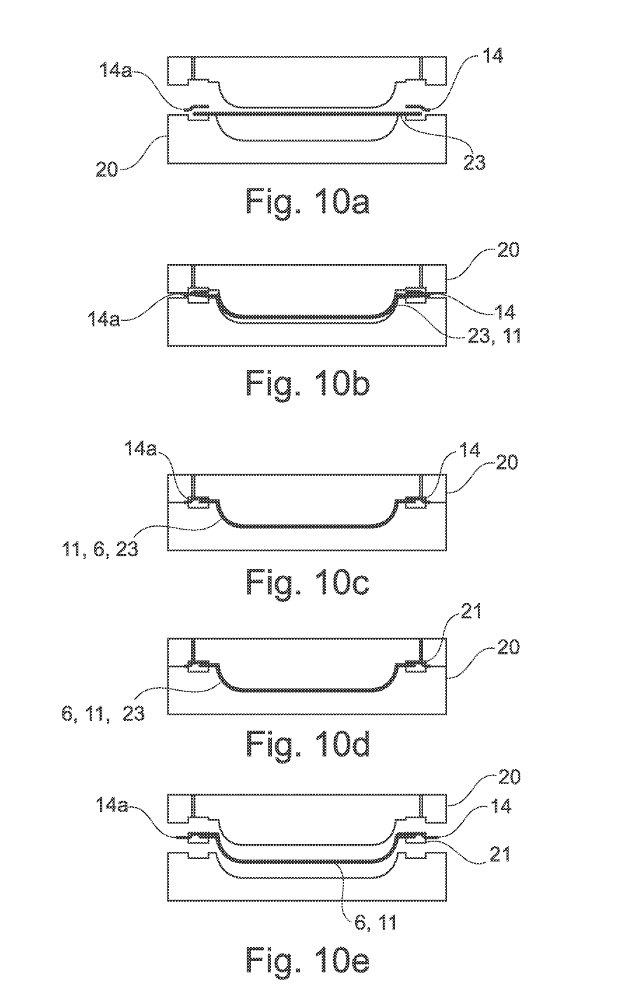

FIGS. 10a to 10e show schematically the production of a first housing section 6 from a moulded blank 23 with the introduction of a second polymer material 21 into the peripheral area of moulded blank 23 and first housing section 6, with formation of an accommodation space 11 for an electrode assembly 2, with overmoulding of current collector 14, 14a and of the peripheral area of moulded blank 23, in a processing device 20. Although it is not shown, moulded blank 23 has the first bearing element, at least one of said functional devices and the second bearing element. Advantageously, first bearing element 7 and second bearing element 7a have the form of base courses.

FIG. 10a shows moulded blank 23 and current collectors 14, 14a, which are inserted in the processing device, here in the form of a moulding tool 20. The two-part moulding tool is not yet closed. One part of moulding tool 20 is formed with a depression, the other part of moulding tool 20 is formed with a protrusion. The depression and the protrusion cooperate to form an accommodation space in moulded blank 23 or in first housing section for the electrode assembly, which is not shown. Before moulding tool 20, furnished with a depression and a protrusion, is closed, moulded blank 23 is heated to a working temperature, which is at least equivalent to the softening temperature of the first polymer material.

FIG. 10b shows moulding tool 20 during the closing process, wherein accommodation space 11 is created in moulded blank 23 by the depression and the protrusion. At the same time, moulded blank 23 has a working temperature that is as least equivalent to the softening temperature of the first polymer material.

FIG. 10c shows the closed moulding tool 20. After plastic deformation, the moulded blank 23 placed includes accommodation space 11. Current collectors 14, 14a are retained in predefined positions relative to moulded blank 23 inside moulding tool 20, particularly in the peripheral area of the moulded blank 23. Moulded blank 23 is preferably at a working temperature that is at least equivalent to the softening temperature of first polymer material, particularly so that moulded blank 23 is able to enter into a close material bond with the second polymer material, not shown.

FIG. 10d shows the closed moulding tool 20 and the inserted moulded blank 23 according to FIG. 10c at a later time. Warmed second polymer material 21 is introduced into moulding tool 20 through two channels. The second polymer material 21 fills cavities provided in moulding tool 20, which cavities are arranged in peripheral areas of moulded blank 23. The current collectors 14, 14a also protrude through the cavities. With the introduction of second polymer material 21, the peripheral areas of moulded blank 23 and current collectors 14, 14a are overmoulded. Moulded blank 23 preferably has a working temperature that is at least equivalent to the softening temperature of the first polymer material, particularly so that moulded blank 23 is able to participate in close material bonds with second polymer material 21.

After the introduction of second polymer material 21, the temperature thereof and the temperature of the deformed moulded blank 23 is lowered until it also falls below the softening temperature of the first polymer material. First housing section 6 is then ready for removal.

FIG. 10e shows the open moulding tool 20 and the demoulded first housing section 6. First housing section 6 has the two bearing elements, at least of said functional devices, second polymer material 21 in the peripheral area, accommodation space 11, and current collectors 14, 14a. After first housing section 6 has been removed, moulding tool 20 is ready to produce the next first housing section.

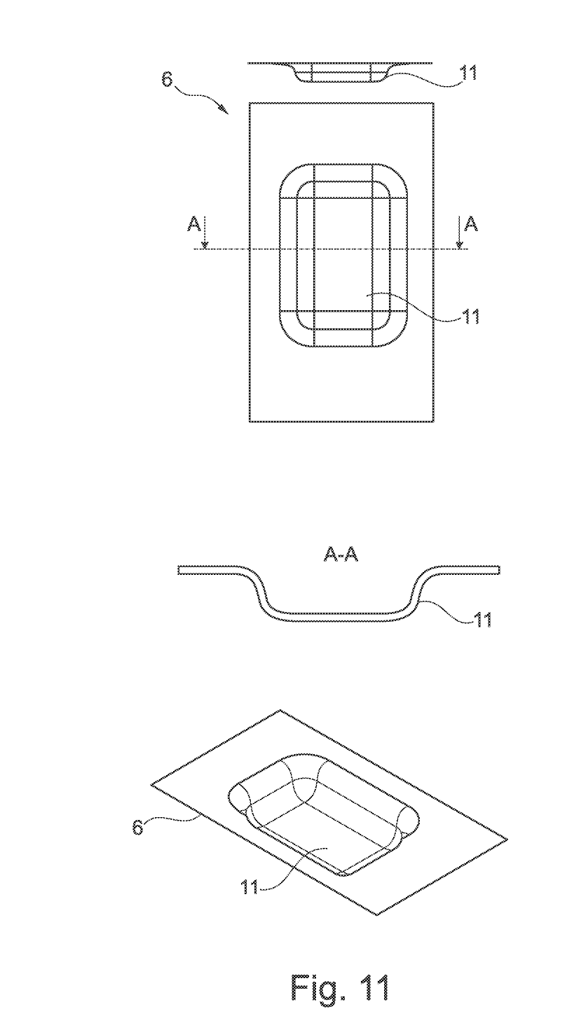

FIG. 11 shows various view and cross sections of a first housing section 6 with an accommodation space 11 for an electrode assembly.

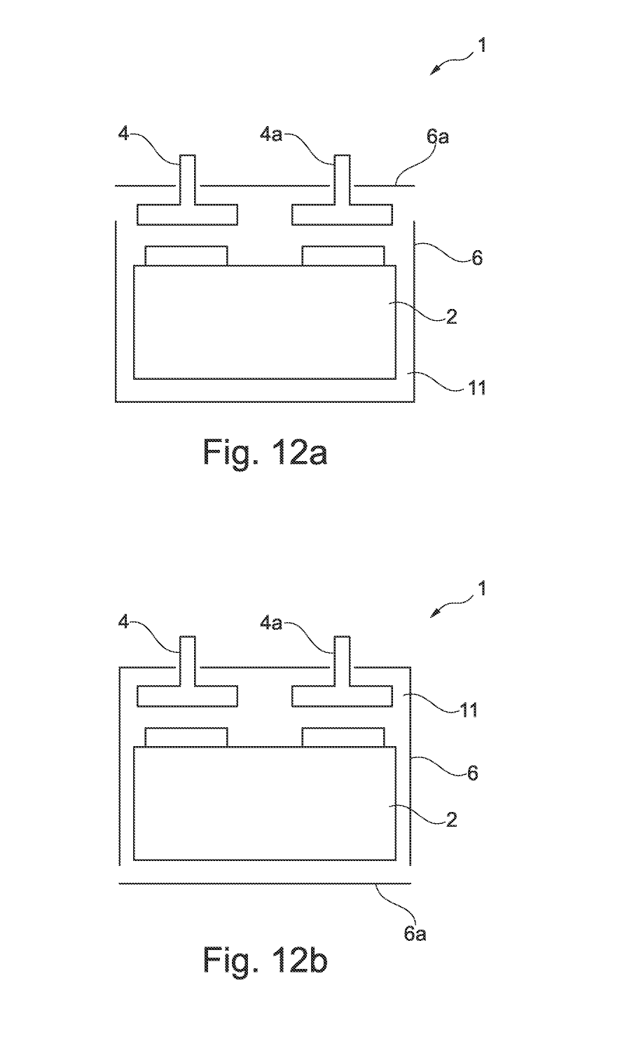

FIGS. 12a and 12b are schematic views of a converter cell 1 with a two-part cell housing 5, wherein first housing section 6 is in the form of a cup and second housing section 6a is in the form of a cover. The interior cavity of the cup corresponds to accommodation space 11. Second polymer material, which is arranged in the peripheral areas of housing sections 6, 6a, is not shown. Two current conducting devices 4, 4a extend at least in areas thereof though one of the housing sections and into the area outside converter cell 1.

FIG. 12a shows that current conducting devices 4, 4a are routed through second housing section 6a and to the outside. It is not shown that current conducting devices 4, 4a are connected materially, and particularly in gas-tight manner, to second housing section 6a.

FIG. 12b shows that current conducting devices 4, 4a are routed through first housing section 6 and to the outside. It is not shown that current conducting devices 4, 4a are connected materially, and particularly in gas-tight manner, to first housing section 6.

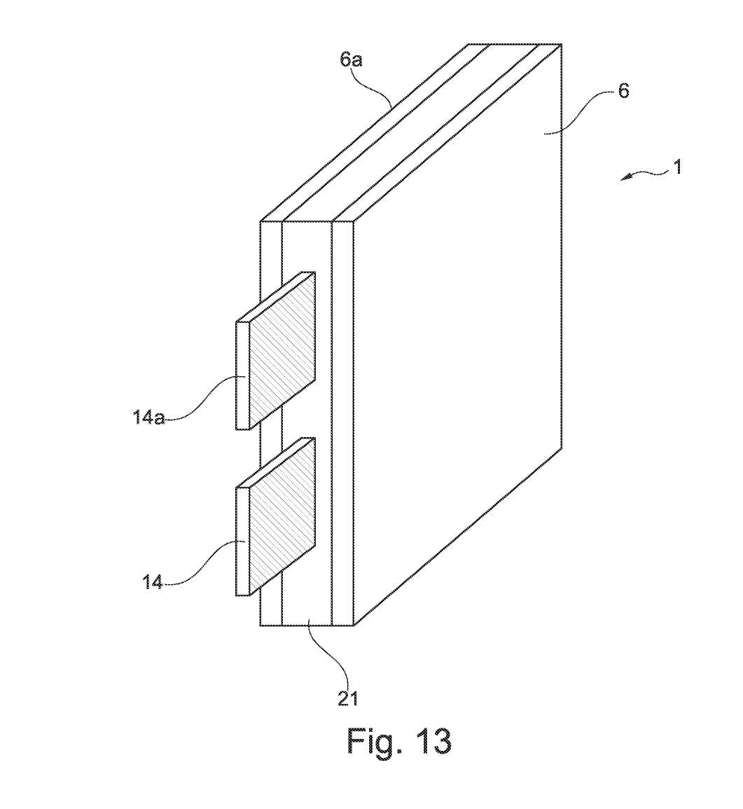

FIG. 13 is a schematic view of a converter cell 1 having a two-part cell housing 5, wherein housing sections 6, 6a are kept at a distance from one another by a frame made from second polymer material 21. The electrode assembly, not shown, is accommodated by the frame. Thus, housing sections 6, 6a are each constructed without an accommodation space. Two of these current collectors 14, 14a extend out of frame 21 and into the area outside converter cell 1.

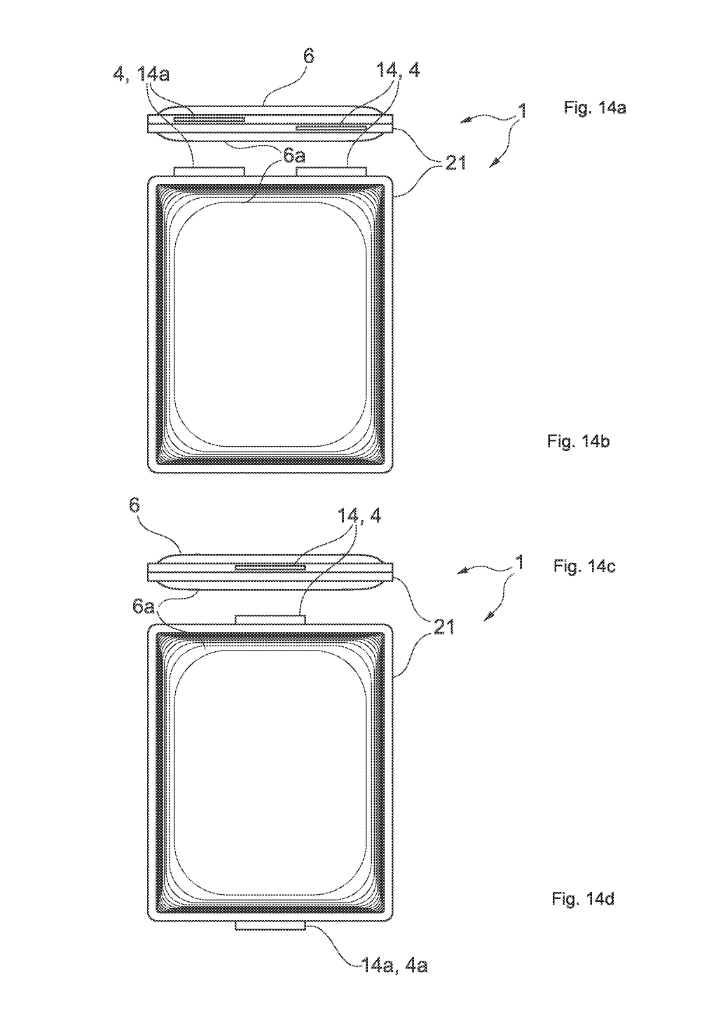

FIGS. 14a to 14d shows schematic views of further preferred embodiments of converter cells 1, each having a two-part cell housing 5 and each having two current collectors 14, 14a, which extend into the area outside converter cell 1. Peripheral areas of these housing sections 6, 6a are each surrounded by second polymer material 21. These peripheral areas are connected to each other materially, and particularly in gas-tight manner. Thus, housing sections 6, 6a together form the cell housing around the electrode assembly, which is not shown. Current collectors 14, 14a extend out of various housing sections 6, 6a, particularly out of second polymer material 21, which connects each of these current collectors individually with one of said housing sections in gas-tight manner. Housing sections 6, 6a are each constructed with one accommodation space. The two housing sections 6, 6a are advantageously constructed symmetrically. In this way, storage costs are reduced.

FIGS. 14a and 14b show a converter cell 1, in which current collectors 14, 14a extend in the same direction out of the cell housing.

FIGS. 14c and 14d show a converter cell 1, in which current collectors 14, 14a extend in opposite directions out of the cell housing.

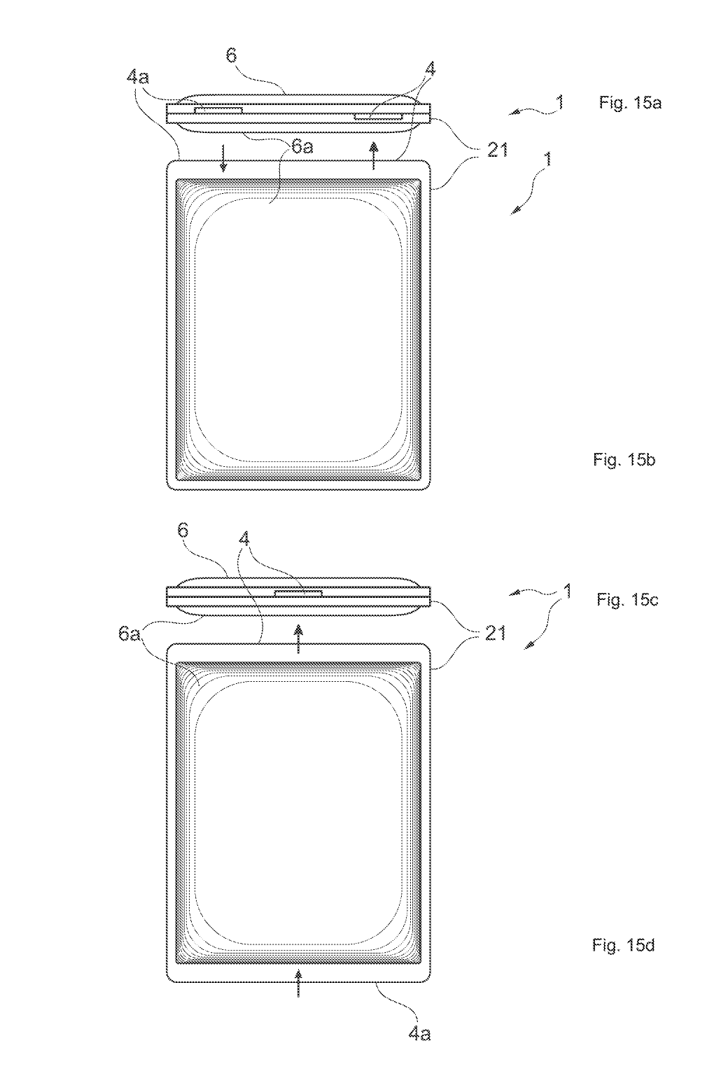

FIGS. 15a to 15d show schematic views of further preferred embodiments of converter cells 1, each having a two-part cell housing 5 and with current conducting devices 4, 4a, each of which essentially terminates at one shell surface of cell housing 5. Peripheral areas of these housing sections 6, 6a are each surrounded by second polymer material 21. These peripheral areas connected to each other by material connection, particularly in gas-tight manner. Thus, housing sections 6, 6a together form the cell housing around the electrode assembly, which is not shown. Current conducting devices 4, 4a are arranged in different housing sections 6, 6a, particularly in each second polymer material 21 that connects each one of said current conducting devices to each one of said housing sections in gas-tight manner. Current conducting devices 4, 4a terminate with shell surfaces of different housing sections 6, 6a. Housing section 6, 6a are constructed with one accommodation room each. The two housing sections 6, 6a are advantageously constructed symmetrically. In this way, storage costs are reduced.

FIGS. 15c and 15d show a converter cell 1 in which current conducting devices 4, 4a extend in opposite directions.

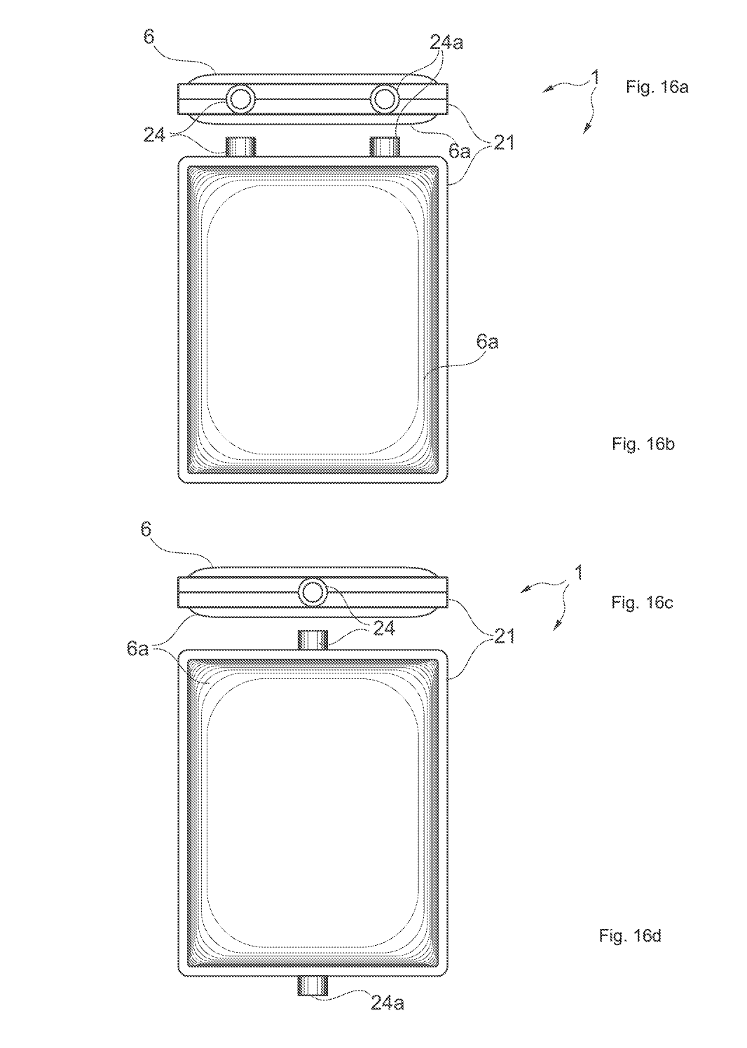

FIGS. 16a to 16d shows schematic views of further preferred embodiments of converter cells 1, each having a two-part cell housing 5 and converter assembly 2 and two fluid passthroughs 24, 24a. Not shown are the current conducting devices of converter cell 1. Peripheral areas of said housing sections 6, 6a are each surrounded by second polymer material 21. These peripheral areas are connected materially, particularly in gas-tight manner with each other. Thus housing sections 6, 6a together form the cell housing about converter assembly 2, which is not shown. Fluid passthroughs 24, 24a extend out of the cell housing, particularly out of the second polymer material, into the area outside converter cell 1. First fluid passthrough 24 serves for supply of fuel. The second fluid passthrough 24a serves not only to supply fuel but also to transport reactant away. For this purpose, second fluid passthrough 24a has a separating wall, not shown.

FIGS. 16a and 16c shown a converter cell 1, of which the fluid passthroughs 24, 24a extend in the same direction.

FIGS. 16c and 16d show a converter cell 1, of which the fluid passthroughs 24, 24a extend in opposite directions.

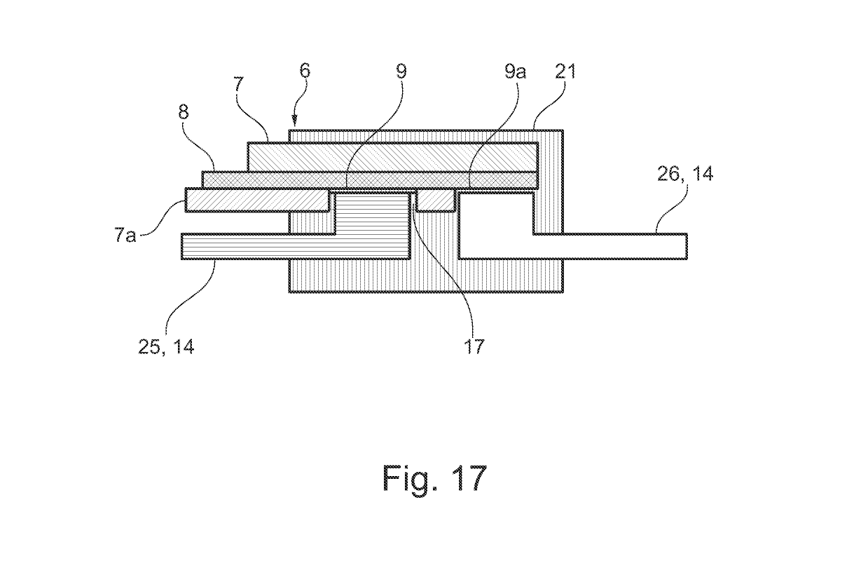

FIG. 17 shows a schematic view of a cross section through a first housing section 6 with a two-part current collector 14 according to a preferred embodiment of the converter cell, particularly according to the fifth preferred embodiment of the converter cell.

The two-part current collector 14 has tab connecting section 25 for electrical connection with electrode tabs, not shown, Two-part current collector 14 further has connector connecting section 26 for electrical connection to a connector device that is not shown and does not belong to the converter cell, for example a power cable or power strip. Second polymer material 21 is arranged in the peripheral area of first housing section 6. Second polymer material 21 encloses two-part current collector 14, first bearing element 7, functional device 8 and second bearing element 7a with a gas-tight and/or material connection.

Functional device 8 has an electrode connecting area 9 and a connector contact area 9a. Second bearing element 7a has s contacting recess 17 and adjacent to connector contact area 9a a further recess. One projection each of tab connecting section 25 and connection connecting section 26 extends through these recesses to electrode connecting area 9 and connector contact area 9a.

Parts of functional device 8 that are not shown are: a current limiter, a current probe, a cell control device, multiple conducting paths, a thermocouple and preferably a first short-range radio device. The cell control device is intended to regulate the cell current by means of the current limiter, the thermo element and preferably the first short-range radio during charging and/or discharging of the converter cell, and the electrode assembly, to control or preferably avoid an undesirably high temperature of the electrode assembly.

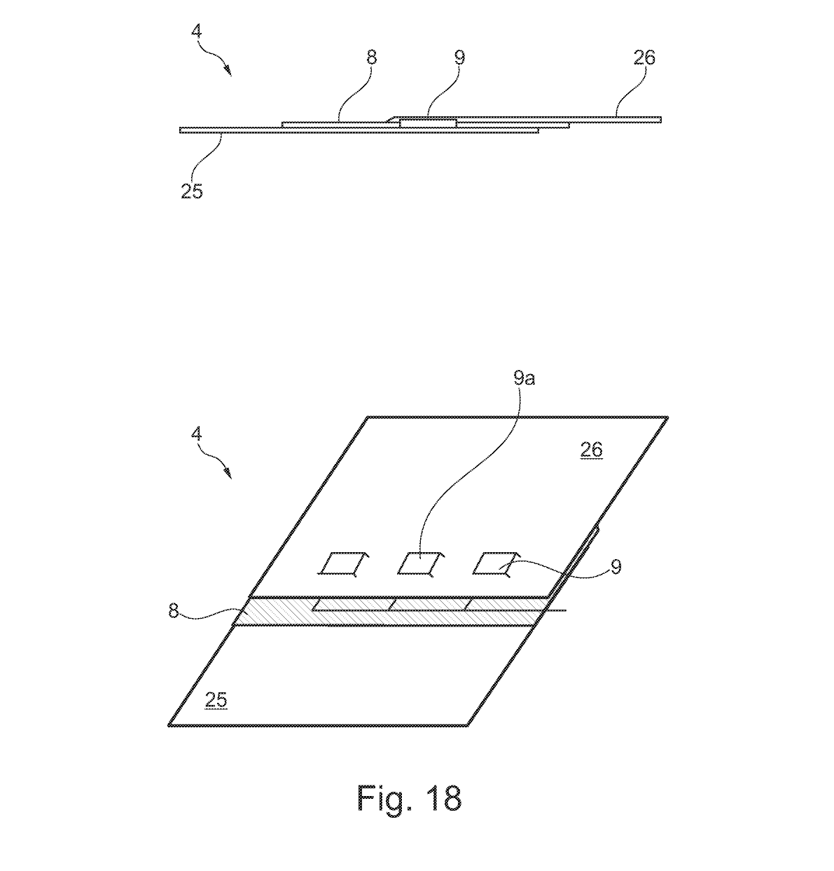

FIG. 18 is shows a schematic view of a detail of a current conducting device 4 of another embodiment of a converter cell 1 according to the fifth preferred embodiment.

Represented is a two-part current collector 14 of current conducting device 4 with a tab connecting section 25 and a connector connecting section 26. Tab connecting section 25 and connector connecting section 26 are realised in the form of metal strips. Functional device 8 is arranged between tab connecting section 25 and connector connecting section 26. Functional device 8 is designed to be electrically insulating in the area between tab connecting section 25 and connector connecting section 26. Functional device 8 has functional elements 9, 9a, wherein functional elements 9, 9a are in the form of a semiconductor switch, particularly field effect transistor. This semiconductor switch is designed so as to connect tab connecting section 25 with connector connecting section 26 electrically, particularly triggered by the cell control device, not shown.

These semiconductor switches 9, 9a are arranged in recesses of connector connecting section 26 and are also electrically connected with connector connecting section 26 in the area of these recesses. Additional connections of these semiconductor switches 9, 9a are connected to tab connecting section 25.

Since tab connecting section 25 and connector connecting section 26 are each realised as metal plates and semiconductor switches 9, 9a are in flush contact with these metal plates, tab connecting section 25 and connector connecting section 26 function as heat sinks.

### LIST OF REFERENCE SIGNS

1 Converter cell
2 Electrode assembly, Converter assembly
3, 3a Electrode
4, 4a Current conducting device
5 Cell housing
6, 6a, 6b Housing section
7, 7a Bearing element
8, 8a, 8b Functional device
9, 9a Functional element
10, 10a Layer area
11 Accommodation space
12, 12a Contacting area
13 Electrode tab
14, 14a Current collector
15, 15a Pole contact recess
16, 16a Pole contact area
17, 17a Contacting recess
18 Layered bond
19 Storage facility
20 Processing device, Moulding tool
21 Second polymer material, Frame from second polymer material
22 Insert
23 Moulded blank
24, 24a Fluid passthrough
25 Tab connecting section of the current collector
26 Connector connecting section of the current collector

1-17. (canceled)

18. A converter cell, particularly constructed as an electrochemical energy converter, comprising:
a rechargeable electrode assembly, which is designed to at least temporarily make electrical energy available to a consumer that has at least two electrodes of different polarity;
a current conducting device, that is designed to be electrically connected with one of the electrodes of the electrode assembly; and
a cell housing with a first housing section, wherein that cell housing is designed to enclose at least areas of the electrode assembly, wherein the first housing section has at least a functional device, that is designed to support the release of energy from the electrode assembly particularly to a consumer, which is operatively connected to the electrode assembly, particularly for the uptake of energy, and
a first bearing element that is designed to brace the at least one functional device.

19. The converter cell according to claim 18, wherein
at least one of said current conducting devices has at least one electrode tab, which is constructed for particularly material connection with one of the electrodes of the electrode assembly, particularly in the cell housing.

20. The converter cell according to claim 19, wherein the current conducting device has:
an essentially plate-like, metal or metal-coated current collector, which is constructed for electrical, particularly material connection with the at least one electrode tab, which extends into the interior of the cell housing, or
an essentially plate-like, metal or metal-coated current collector, which is constructed for electrical, particularly material connection with one of these functional devices, which extends at least partly out of the cell housing into the area outside the converter cell, wherein the at least one electrode tab is electrically, particularly materially, connectable with the same functional device, or
a two-part, essentially plate-like, metal or metal-coated current collector, with a tab connecting section and a connector connecting section,
wherein the tab connecting section extends at least partly into the interior of the cell housing and is constructed for electrical, particularly material connection with the at least one electrode tab,
wherein the connector connecting section extends at least partly out of the cell housing into the area surrounding the converter cell and is constructed for electrical, particularly force fitting connection with a connection device not associated with the converter cell,
wherein the tab connecting section and the connector connecting section are electrically, particularly materially, connectable with the same of these functional devices,
wherein the tab connecting section and the connector connecting section are reversibly electrically interconnectable with each other via this functional device.

21. The converter cell according to claim 18, wherein the at least one functional device has at least one functional element, wherein the at least one functional element is operatively connected, particularly electrically connected, to the electrode assembly.

22. The converter cell according to claim 21, wherein the at least one functional element is constructed as a pole contact area, electrode connecting area, conductor path, recess, voltage probe, current probe, temperature probe, pressure sensor, substance sensor, gas sensor, liquid sensor, position sensor, acceleration sensor, control device, application specific, integrated circuit, microprocessor, switching device, semiconductor switch, circuit breaker, current limiter, discharge resistor, pressure relief device, fluid passthrough, final controlling device, actuator, data storage device, buzzer, light emitting diode, infrared interface, GSM assembly first short-range radio device or transponder.

23. The converter cell according to claim 18, wherein the at least one functional device at least
has a partly porous construction, and/or
includes a cavity structure, particularly a honeycomb structure, in areas thereof, and/or
has a cavity for a temperature control medium, and/or
has an expandable filler in areas thereof, which is designed to form cavities particularly upon application of activation energy or upon triggering by a functional element, and/or
has an expandable filler in areas thereof, which has phase transition capability, particularly within the predetermined operating temperature range of the converter cell (1), and/or
has a chemically reactive filler in areas thereof, and/or
has a first layer area having a first wall thickness and a second layer area having a second wall thickness, wherein the fraction resulting from dividing the second wall thickness by the first wall thickness is equal to a predetermined value less than 1.

24. The converter cell according to claim 18, wherein the cell housing has a second housing section, and wherein the second housing section:
is designed so as to be connected to the first housing section, particularly with a material connection, at last in areas thereof,
is designed so as to form the cell housing of the converter cell in conjunction with the first housing section, and
has a first bearing element that is designed to delimit the electrode assembly with respect to the area outside the converter cell.

25. The converter cell according to claim 18, wherein the first cell housing section and/or the second housing section
has an accommodation space that is designed to at least partially accommodate the electrode assembly, and/or
has a second bearing element that is arranged particularly adjacent to functional device and facing the electrode assembly, and/or
has a second polymer material in a peripheral area of the housing section, wherein the second polymer material serves to provide a particularly material connection with another housing section.

26. The converter cell according to claim 18, wherein the cell housing has an essentially plate-like third housing section, and wherein the third housing section
is designed to be connected to the first housing section, at least in areas thereof, particularly in material connection with the cell housing, and/or
has greater thermal conductivity that the first housing section, and/or
has a first heat transfer area that is designed for the exchange of thermal energy with the electrode assembly.

27. The converter cell according to claim 18, wherein the at least one current conducting device has a contacting area, and wherein the contacting area serves to provide electrical contacting to the functional device.

28. The converter cell according to claim 18, wherein
at least one of said functional devices is arranged between the first bearing element and the second bearing element,
the first bearing element has at least one pole contact recess that particularly makes an area of the adjacent functional device accessible, particularly electrically contactable, from the area surrounding the converter cell,
at least one of said functional devices has at least one of said pole contact areas particularly in the area of the at least one pole contact recess that has the potential of one of the electrodes of the electrode assembly,
the second bearing element has a contacting recess adjacent to the contacting area of the current conducting device,
the functional device has the electrode contacting area particularly in the area of the contacting recess as the functional element, which electrode connecting area is particularly facing the current conducting device, and
an electrical connection is created between the current conducting device, particularly the contacting area thereof, and the functional device, particularly for the supply of electrical energy to the functional device or at least one functional element via the electrode assembly.

29. The converter cell according to claim 18, comprising a housing assembly with the first housing section and at least one of said current conducting devices, which are connected with electrodes of different polarity, wherein:
the first housing section has a particularly materially connected layered bond from at least the first bearing element of at least one functional device with at least one functional element and the second bearing element,
the first housing section has a second polymer material particularly in the peripheral area thereof, wherein the peripheral area,
the first housing section has an accommodation space, wherein the accommodation space is designed to accommodate at least part of the electrode assembly,
at least one of these current conducting devices has the contacting area, wherein the contacting area is arrange in the peripheral area of the first housing section,
the second bearing element has the contacting recess in the contacting area of at least one of said current conducting devices, and
the contacting area is particularly electrically connected to the functional device, particularly to the electrode connecting area thereof, via the contacting recess.

30. The converter cell according to claim 18, wherein
the at least one of said functional devices has one of said cell control devices and at least one of said sensors,
the at least one sensor is designed to capture an operating parameter of the converter cell, particularly the electrode assembly, and to make it available to the cell control device, and
the cell control device is designed to control at least one operating process of the converter cell, particularly the charging and/or discharging of the electrode assembly.

31. The converter cell according to claim 18, wherein the converter cell
is designed to take up and/or release a charge of at least 10 Ah, and/or
is designed to supply a current of at least 50 A, and/or
is designed to supply a voltage of at least 3.5 V, and/or
is operable within a temperature range from −40° C. to +100° C., and/or
has a gravimetric energy density of at least 50 Wh/kg.

32. A secondary battery comprising at least two converter cells according to claim 18, with a battery controller.

33. A method for producing a converter cell according to claim 18, wherein the converter cell comprises (a) an electrode assembly with at least two electrodes of different polarity, (b) two current conducting devices, wherein the first current conducting device is connected to the electrode having a first polarity and the second current conducting device is connected to the electrode having a second polarity, (c) a cell housing with a first housing section, wherein the first housing section has a first bearing element and at least one functional device with at least one functional element, wherein the first bearing element serves to brace the at least one functional device, wherein the first bearing element has a first polymer material, wherein the at least one functional device is particularly materially connected to the first bearing element at least in areas thereof, wherein at least one of said functional devices is operatively connected to the electrode assembly, wherein the method serves particularly to close the cell housing about the electrode assembly, the method comprising the following steps:
(S17) supplying the first housing section or the particularly deformed moulded blank;
(S19) placing the electrode assembly together with the first housing section, particularly placing the electrode assembly in the accommodation space of the first housing section;
(S20) creating an electrical connection between the electrode assembly and at least one or more of said current conducting devices, particularly in a joining process;
(S23) placing the second housing section together with the first housing section; and
(S26) creating particularly a material connection between the second housing section or the third housing section and the first housing section, particularly under the effect of heat, particularly at a working temperature, which is at least equivalent to the softening temperature of the second polymer material, wherein preferably a peripheral area of first housing section is connected to the second housing section or the third housing section.

34. The method according to claim 33, particularly for producing the converter cell, particularly for producing the first and/or second housing section, comprising the steps:
(S11) feeding the essentially flat moulded blank into a processing device, particularly a moulding device,
(S12) inserting at least one or more of said current conducting devices in the processing device, particularly in the moulding tool, particularly in addition to the essentially flat moulded blank,
(S14) adding a particularly readily flowable second polymer material, to the moulded blank in the processing device, particularly in the moulding tool, wherein the second polymer material is arranged in the peripheral area of the moulded blank, particularly at a working temperature that is at least equivalent to the softening temperature of the second polymer material,
(S15) solidifying the deformed moulded blank, and
(S16) removing the particularly deformed moulded blank, hereinafter also called the first housing section, from the processing device, particularly at a removal temperature that is lower than the softening temperature of the first polymer material.

35. The method according to claim 33, particularly for producing a layered bond for the first or second housing section, wherein the layered bond includes the first bearing element, at least one or more of said functional devices and preferably the second bearing element, comprising the following steps:
(S2) providing the first bearing element, which has a first polymer material that is particularly interfused with fibres,
(S3) placing at least one or more of said functional devices or functional assemblies,
(S4) making particularly material connections between the first bearing element and at least one of said functional devices, preferably under the effect of heat, preferably by means of an isotactic or continuous press, on which the layered bond is formed.

36. The method according to claim 33, particularly for closing the cell housing about the electrode assembly, particularly to produce the first preferred refinement of the first preferred embodiment of the converter cell, comprising the steps:
S11, wherein one of said moulded blanks is introduced into a processing device together with one of said functional devices, wherein said functional device has at least one of said electrode connecting areas
S12, wherein at least one of said current conducting devices or the current collectors thereof are added to said moulded blank in the moulding tool and are arranged there in the peripheral area of the moulded blank or the future first housing section
S10, S13 and S14, whereupon an accommodation space for the electrode assembly is created in the moulded blank and second polymer material is arranged in the peripheral area of the moulded blank in such manner that the inserted current conducting devices or the current collectors thereof are enclosed by the second polymer material, particularly in gas-tight manner,
S15, whereupon the softened first polymer material of the first bearing element hardens again and the resulting first housing section can be removed from the moulding tool,
S18, for equipping the electrode assembly with at least one or more said electrode tabs, wherein the electrode tabs are connected to at least one of said electrodes with a first polarity or to at least one of said electrodes with a second polarity,
S17 and S19, with which the electrode assembly is added to the first housing section provided in the processing device, preferably arranged in the accommodation space of the first housing section,
S21, wherein said electrode tabs that are connected to said electrodes with first polarity, and said electrode tabs that are connected to said electrodes with second polarity are electrically connected to various current collectors, particularly via a joining process,
S23, wherein the second housing section is added to the first housing section and the electrode assembly in the processing device, wherein at least one of said peripheral areas of the first housing section and at least one of said peripheral areas of the second housing section are arranged adjacent to each other, and
S26, wherein particularly the peripheral areas are connected to each other particularly by a material connection, particularly at a working temperature that is at least equivalent to the softening temperature of the second polymer material.

37. A method for producing a converter cell according to claim 18, wherein the converter cell comprises (a) an electrode assembly with at least two electrodes of different polarity, (b) two current conducting devices, wherein the first current conducting device is connected to the electrode having a first polarity and the second current conducting device is connected to the electrode having a second polarity, (c) a cell housing with a first housing section, wherein the first housing section has a first bearing element and at least one functional device with at least one functional element, wherein the first bearing element serves to brace the at least one functional device, wherein the first bearing element has a first polymer material, wherein the at least one functional device is particularly materially connected to the first bearing element at least in areas thereof, wherein at least one of said functional devices is operatively connected to the electrode assembly, wherein the method serves particularly to close the cell housing about the electrode assembly, the method comprising the following steps:
(S17) supplying the first housing section or the particularly deformed moulded blank;
(S19) placing the electrode assembly together with the first housing section, particularly placing the electrode assembly in the accommodation space of the first housing section;
(S20) creating an electrical connection between the electrode assembly and at least one or more of said current conducting devices, particularly in a joining process;
(S24) placing the third housing section together with the first housing section; and
(S26′) creating particularly material connection between the second housing section or the third housing section and the first housing section, particularly using a sealing and/or bonding material, or (S26″) creating particularly a material connection between the second housing section or the third housing section and the first housing section, wherein the second polymer material is arranged in the peripheral area of at least one of the housing sections, particularly at a temperature that is at least equivalent to the softening temperature of the second polymer material.
